(19) United States
(12) Patent Application Publication
(10) Pub. No.: US 2012/0187922 A1
(43) Pub. Date: Jul. 26, 2012

(54) ENERGY STORAGE SYSTEM AND METHOD

(76) Inventors: Maxime R. DUBOIS, Levis (CA); Michael Desjardins, Quebec (CA); Louis Tremblay, Quebec (CA)

(21) Appl. No.: 13/324,675

(22) Filed: Dec. 13, 2011

Related U.S. Application Data
(63) Continuation-in-part of application No. PCT/CA2010/000922, filed on Jun. 15, 2010.
Application No. PCT/CA2010/000922 is a continuation-in-part of application No. PCT/CA2010/000919, filed on Jun. 15, 2010.
Application No. PCT/CA2010/000919 is a continuation-in-part of application No. PCT/CA2010/000920, filed on Jun. 15, 2010.
Application No. PCT/CA2010/000920 is a continuation-in-part of application No. PCT/CA2010/000921, filed on Jun. 15, 2010.
(60) Provisional application No. 61/187,170, filed on Jun. 15, 2009.
(60) Provisional application No. 61/187,174, filed on Jun. 15, 2009.
(60) Provisional application No. 61/187,176, filed on Jun. 15, 2009.
(60) Provisional application No. 61/233,664, filed on Aug. 13, 2009.
(60) Provisional application No. 61/187,170, filed on Jun. 15, 2009.
(60) Provisional application No. 61/233,664, filed on Aug. 13, 2009.
(60) Provisional application No. 61/187,174, filed on Jun. 15, 2009.
(60) Provisional application No. 61/233,664, filed on Aug. 13, 2009.
(60) Provisional application No. 61/187,176, filed on Jun. 15, 2009.
(60) Provisional application No. 61/233,664, filed on Aug. 13, 2009.

(51) Int. Cl. H02K 7/02

(52) U.S. Cl. 322/4

(57) ABSTRACT

An system for storing electrical energy over at least a medium term duration. The energy storage system comprises a motor assembly operatively connectable to at least one of an electrical energy source and an electrical distribution network for providing kinetic energy, a flywheel device operatively connectable to the motor assembly for storing at least one part of the kinetic energy, a generator assembly operatively connectable to the flywheel device for receiving at least one portion of the part of the kinetic energy and generating regenerated electrical energy in response thereto, and a control unit for controlling operation of the energy storage system, which enables an energy storage operating mode for storing the part of the kinetic energy into the flywheel device, and an energy supply operating mode for providing at least one portion of the regenerated energy to at least one of the electrical distribution network and an electrical appliance.

### CROSS REFERENCE TO RELATED APPLICATIONS

This application is a Continuation-in-Part Application of PCT International Application No. PCT/CA2010/000922, entitled “ENERGY STORAGE SYSTEM AND METHOD”, International Filing Date Jun. 15, 2010, published on Dec. 23, 2010 as International Publication No. WO 2010/145021, which in turn claims priority from U.S. Provisional Patent Application No. 61/187,170, filed Jun. 15, 2009, U.S. Provisional Patent Application No. 61/187,174, filed Jun. 15, 2009, U.S. Provisional Patent Application No. 61/187,176, filed Jun. 15, 2009 and U.S. Provisional Patent Application No. 61/233,664, filed Aug. 13, 2009, all of which are incorporated herein by reference in their entirety.

This application is a Continuation-in-Part Application of PCT International Application No. PCT/CA2010/000919, entitled “DUAL SWITCHING FREQUENCY HYBRID POWER CONVERTER”, International Filing Date Jun. 15, 2010, published on Dec. 23, 2010 as International Publication No. WO 2010/145019, which in turn claims priority from U.S. Provisional Patent Application No. 61/187,170, filed Jun. 15, 2009 and U.S. Provisional Patent Application No. 61/233,664, filed Aug. 13, 2009, all of which are incorporated herein by reference in their entirety.

This application is a Continuation-in-Part Application of PCT International Application No. PCT/CA2010/000920, entitled “SYSTEM FOR DECOUPLING A ROTOR FROM A STATOR OF A PERMANENT MAGNET MOTOR AND FLYWHEEL STORAGE SYSTEM USING THE SAME”, International Filing Date Jun. 15, 2010, published on Dec. 23, 2010 as International Publication No. WO 2010/145020, which in turn claims priority from U.S. Provisional Patent Application No. 61/187,174, filed Jun. 15, 2009 and U.S. Provisional Patent Application No. 61/233,664, filed Aug. 13, 2009, all of which are incorporated herein by reference in their entirety.

This application is a Continuation-in-Part Application of PCT International Application No. PCT/CA2010/000921, entitled “HIGH ENERGY DENSITY FLYWHEEL”, International Filing Date Jun. 15, 2010, published on Dec. 29, 2010 as International Publication No. WO 2010/148481, which in turn claims priority from U.S. Provisional Patent Application No. 61/187,176, filed Jun. 15, 2009 and U.S. Provisional Patent Application No. 61/233,664, filed Aug. 13, 2009, all of which are incorporated herein by reference in their entirety.

### FIELD OF THE INVENTION

The invention relates to energy storage systems and more particularly pertains to an energy storage system for medium and long term energy storage.

### BACKGROUND OF THE INVENTION

Energy storage systems are widely used in a range of applications where electrical power is needed. These storage systems enable to store energy under various forms and to restitute the stored energy when needed.

For example, electrical energy may be stored in batteries while rotating flywheels may be used to store the energy under a kinetic form.

Batteries are today still widely used in a lot of applications since they are very convenient to operate. Batteries store electrical energy under a chemical form during the charge thereof and restitute the stored energy under an electrical form during the discharge thereof.

However, as well known in the art, the number of times a conventional battery may be charged once again is limited. The batteries must then be replaced very often, which is a great drawback, especially in applications where the batteries are frequently charged and discharged.

Moreover, conventional batteries, which typically use chemical acid and/or polluting elements such as lead, are also known to generate environmental issues.

Flywheel energy storage systems are generally known to supply high power during a short period of time. They are reliable, may be maintained at a low cost and have a long service life. For example, a typical flywheel may provide over 20 years of operational life without requiring expensive maintenance.

In the art, a flywheel energy storage system typically comprises a motor-generator for enabling the electro-mechanical conversion from electric to kinetic energy and vice versa. It also comprises a rotating disc, also called a flywheel, which is operatively connected to the shaft of the motor-generator to store kinetic energy (E) therein according to the weight (M) of the disc, the square of the radius (R) of the disc and the square of the rotating speed (w) of the disc.

In a typical flywheel storage system, there are four types of losses: aerodynamics, electrics, magnetics and by friction. The latest are caused by the friction between two pieces, such as between the mechanical bearings of the system. They are proportional to the rotating disc weight and to the square of the rotating speed. The magnetic losses are produced by the variation of the magnetic induction in ferromagnetic material and they are proportional to the square of the rotating speed of the disc. They can be found in the motor-generator or in the magnetic bearings. The electric losses or copper losses are found in the copper coil of the motor-generator or in the magnetic bearings of the system. Finally, aerodynamic losses are essentially the losses due to the friction of the rotating parts of the flywheel with the air, generally in a containment vessel surrounding the flywheel.

Minimizing those losses is not easy to achieve because they are all interrelated. For instance, the reduction of friction losses can be achieved with magnetic bearings instead of mechanical bearings, but that particular embodiment will increase the magnetic and electric losses of the whole system. That embodiment will also increase the cost of the energy storage system but is nevertheless generally preferred in the art to accomplish viable long term energy storage.

Permanent magnet motor-generators are known for their high power density, their reliability and their controllability. They are however also known for their iron losses (magnetic losses) at no load and their short range of speed at a constant power, two major drawbacks for the flywheel storage systems of the art.

Typically, a permanent magnet motor-generator can store or retrieve a constant power over a particular speed called base speed. Below the base speed, the motor-generator power decreases linearly with the rotating speed until it reaches zero. Base speed is a particular speed where the voltage created by the variation of the magnetic induction produced by the rotation of the magnet on the rotor in the stator coil is equal to the nominal voltage of the stator. This voltage is called back-electromagnetic-force or back-emf. To overcome that limit, various methods have been proposed in the art.

In a first method, field weakening of the permanent magnet of the rotor is achieved by supplying high current from the inverter that supplies the motor-generator. This method requires the over sizing of the supplying inverter and increases the losses of the inverter and of the motor-generator.

In a second method, the voltage supplied to the motor-generator is increased with a boost converter, thereby allowing to overcome the base speed of the motor-generator. This second method however requires that the electric components of the inverter as well as the motor-generator insulation be adapted to support higher voltage rate.

In order to store a great quantity of energy in the rotating flywheel, it would be desirable to use a rotating disc of a great radius, composed of a heavy material and rotating as fast as possible. However, the disc of the flywheel has to be designed according to the peripheral speed limit of the material that composes the rotating disc. This peripheral speed limit is proportional to the rotating speed and the radius of the disc.

This peripheral speed limit is reached when the tangential pressure on the peripheral of the rotating disc reaches the maximal elastic constrain of the material of the rotating disc. Above that limit, the disc is subject to permanent deformation and breakages may occur, which is highly dangerous and thus undesirable.

As known to the skilled addressee, the maximal elastic constrain is not the same for each material. For instance, the maximal elastic constrain of iron is lower (˜550 MPa) than the one of carbon (˜3 447 MPa), thereby justifying the use of carbon for high speed applications.

Typically, two configurations are used in flywheel energy storage system applications. The first configuration uses heavy material such as iron with a great radius for low speed applications while the second configuration uses light material such as composite material with short radius for high speed applications.

The determination of the material used for the composition of the disc, its weight, its radius and its rotating speed may be chosen according to a given application and also according to the losses found in the different parts of the flywheel and of the flywheel storage system. Indeed, using a high rotational speed may be desirable to store more kinetic energy and to improve the storage duration but it will also increase the overall losses of the whole energy storage system.

As known to the skilled addressee, in the general field of energy storage, power electronics may have a predominant role to play to transmit and control the flow of energy in the most efficient way. For that purpose, power converters for AC to DC and DC to AC voltage conversion may be used.

Such electric power converters are however costly and they lack of reliability in certain circumstances.

To reduce the costs, the use of passive components (inductor and capacitance, mainly for filtering) must be minimized and integrated in the packaging of the converter. The lack of reliability is caused principally by the junction temperature of the semiconductor (power transistor).

One way generally employed in industry to reduce the size of the passive components is by increasing the switching frequency of the converter since their size is decreasing when the switching frequency increases. The trade-off, however, is the increase of the switching losses incurred and the increase of the power transistor temperature. Thus, the space saved by the smaller passive components is more than offset by the need for larger heat sink for evacuating these losses.

Since switching losses are proportional to the switching frequency, they are increased as the switching frequency is also increased. Thus, the use of an increased switching frequency generates an increase in power output losses of the inverter.

It would therefore be desirable to provide an improved energy storage system that will reduce at least one of the above-mentioned drawbacks.

### BRIEF SUMMARY

Accordingly, there is disclosed an energy storage system operatively connectable to at least one of an electrical energy source and an electrical distribution network for storing electrical energy thereof over at least a medium term duration.

The energy storage system comprises a motor assembly operatively connectable to at least one of the electrical energy source and the electrical distribution network for providing kinetic energy. The energy storage system comprises a flywheel device operatively connectable to the motor assembly for storing at least one part of the kinetic energy. The energy storage system also comprises a generator assembly operatively connectable to the flywheel device for receiving at least one portion of the part of the kinetic energy and generating regenerated electrical energy in response thereto.

The energy storage system comprises a control unit for controlling operation of the energy storage system. The control unit enables an energy storage operating mode wherein the motor assembly is operatively connected to the flywheel device and at least one of the electrical energy source and the electrical distribution network for storing the part of the kinetic energy into the flywheel device, and an energy supply operating mode wherein the generator assembly is connected to the flywheel device and at least one of the electrical distribution network and an electrical appliance for providing at least one portion of the regenerated electrical energy thereto.

The energy storage system may provide high efficiency energy storage, particularly for medium and long term energy storage applications, which is of great advantage.

For example, the energy storage system may enable an energy conservation of 95% over a 24 hour period when no energy is extracted from the energy storage system. Moreover, the energy storage system may also enable a round trip efficiency of more than 85%.

The energy storage system may be maintained at a low cost and have a long service life and a great reliability, which is of great advantage. For example, the lifespan of the energy storage system may be over ten years.

In one embodiment, the energy storage system further comprises a permanent magnet motor-generator, the permanent magnet motor-generator comprising the motor assembly and the generator assembly.

In one embodiment, the energy storage system further comprises a bidirectional electronic power converter operatively associated with the motor assembly and the generator assembly, the converter being adapted for converting the regenerated electrical energy into converted electrical energy enabling a corresponding electrical power exchange between the generator assembly and at least one of the electrical distribution network and the electrical appliance.

In one embodiment, the power converter is further adapted for enabling a corresponding electrical power exchange between the electrical distribution network and the motor assembly.

In one embodiment, the permanent magnet motor-generator is operatively connected to each of the flywheel device and the electrical distribution network.

In one embodiment, the electrical energy source comprises at least one stand alone renewable energy source selected from a group consisting of a wind-turbine, a solar panel and a geothermal source.

In one embodiment, the energy storage system further comprises a second power converter for converting the electrical energy supplied by the wind turbine into a converted signal adapted to the motor assembly.

In one embodiment, the energy storage system, further comprises a communication system adapted for sending data to the control unit for remotely controlling each of the energy storage operating mode and the energy supply operating mode.

In one embodiment, the electric appliance comprises at least one electrical terminal adapted for connecting to an electrically operated vehicle for recharging the electrical vehicle.

In a further embodiment, the energy storage system is operatively connected to the electrical energy source, the electrical energy source comprising at least one stand-alone renewable electrical energy source, the generator assembly being operatively connected to the electrical appliance, thereby providing a stand alone configuration of the energy storage system, which is of great advantage.

In one embodiment, the flywheel device comprises a high energy density flywheel having a central rotating axle for storing kinetic energy, the high energy density flywheel comprising a first member to be operatively mounted around the central rotating axle, the first member comprising a first material having a given high mass density enabling a given high kinetic energy storage capacity; and a second member operatively attached to the first member, the second member surrounding an outside portion of the first member subject to radial forces generated by a rotation of the flywheel, the second member comprising a second material having a given high yield strength enabling a given high maximum rotational speed; wherein the second member enables an operation of the high energy density flywheel at a given high flywheel rotational speed, to thereby provide the flywheel with a given high kinetic energy storage capacity.

In a further embodiment, the high energy density flywheel is adapted to be mountable on a rotating shaft operatively connectable to each of the motor assembly and the generator assembly.

In one embodiment, the high energy density flywheel further comprises a magnetic coupling element mounted on an inner side thereof and adapted for interacting with an associated magnetic driving element mountable proximate the central rotating axle.

In one embodiment, the high energy density flywheel further comprises an inner hub fixedly mounted to the rotating shaft via a first coupling and a second coupling mounted on both sides of the inner hub.

In one embodiment, the first member of the high energy density flywheel has a crown shape and is made of a single piece.

In another embodiment, the first material of the high energy density flywheel is selected from a group consisting of steel, lead, tungsten and a combination thereof.

In one embodiment, the second material of the high energy density flywheel is selected from a group consisting of carbon, Kevlar™ and a combination thereof.

In one embodiment, the second material of the high energy density flywheel comprises a composite material.

In one embodiment, the second member of the high energy density flywheel wholly encloses the first member.

In one embodiment, the second member of the high energy density flywheel is belt shaped and extends on a radial outside portion of the first member.

In one embodiment, the given high yield strength of the second material of the high energy density flywheel is greater than a yield strength of the first material.

In a further embodiment, the first member of the high energy density flywheel has a toroidal shape.

In one embodiment, the second member of the high energy density flywheel has an empty toroidal shape wholly enclosing the first member.

In one embodiment, the second member of the high energy density flywheel comprises at least three covers, each being wound on the first member.

In one embodiment, each of the three covers is wound on the first member of the high energy density flywheel according to a respective principal direction thereof.

In a further embodiment, a first one of the three covers is axially wound on the first member, a second one of the three covers is circumferentially wound on the first member and a third one of the three covers is wound at 45 degrees with respect to the first one of the three covers.

In one embodiment, the given high maximum rotational speed of the high energy density flywheel ranges from 4000 rpm to 12000 rpm.

In one embodiment, the high energy density flywheel further comprises a vacuum containment vessel for enclosing the high energy density flywheel therein.

In one embodiment, the high energy density flywheel further comprises superconducting magnetic bearings for supporting the high energy density flywheel.

In one embodiment, the energy storage system further comprises at least one dual switching frequency hybrid power converter adapted to be operatively connected between the permanent magnet motor-generator and at least one of the electrical distribution network and the electrical appliance for voltage conversion, the dual switching frequency hybrid power converter comprising a first leg electrically connected to the permanent magnet motor-generator, the first leg comprising a high side switch and a low side switch serially connected, the high side switch comprising a selected one of a first switching element having low conduction losses and a second switching element having low commutation losses and the low side switch comprising the remaining of a first switching element having low conduction losses and a second switching element having low commutation losses, the first leg further comprising an anti-parallel diode operatively connected in a parallel relationship with the first switching element; and a second leg electrically connected to the permanent magnet motor-generator in a parallel relationship with the first leg, the second leg comprising a high side switch and a low side switch serially connected, the high side switch comprising a selected one of a first switching element having low conduction losses and a second switching element having low commutation losses corresponding to the one selected for the high side switch of the first leg and the low side switch comprising the remaining of a first switching element having low conduction losses and a second switching element having low commutation losses, the second leg further comprising an anti-parallel diode operatively connected in a parallel relationship with the first switching element; wherein each of the first switching elements is operated at a low fundamental frequency and each of the second switching elements is operated at a high frequency greater than the low fundamental frequency for enabling a bidirectional voltage conversion between the first element and the second element.

In one embodiment, each of the first switching elements comprises at least one IGBT.

In one embodiment, each of the first switching elements is selected from a group consisting of a thyristor, a GTO, an IGCT and a MCT.

In one embodiment, each of the second switching elements comprises at least one MOSFET.

In another embodiment, each of the second switching elements comprises at least one fast IGBT.

In one embodiment, each of the first switching elements comprises a plurality of switching devices connected in parallel and each of the second switching elements comprises a plurality of switching devices connected in parallel.

In one embodiment, the anti-parallel diode is integrated with the first switching element.

In one embodiment, each of the first leg and second leg comprises an additional anti-parallel diode operatively connected in a parallel relationship with the corresponding second switching element.

In a further embodiment, the dual switching frequency hybrid power converter further comprises a third leg electrically connected to the permanent magnet motor-generator in a parallel relationship with the first leg and the second leg, the third leg comprising a high side switch and a low side switch serially connected, the high side switch comprising a selected one of a first switching element having low conduction losses and a second switching element having low commutation losses corresponding to the one selected for the high side switch of the first leg and the low side switch comprising the remaining of a first switching element having low conduction losses and a second switching element having low commutation losses, the third leg further comprising an anti-parallel diode operatively connected in a parallel relationship with the first switching element, thereby enabling a three phase voltage conversion.

In one embodiment, the low fundamental frequency is comprised between 1 Hz and 1000 Hz.

In one embodiment, the high frequency is comprised between 1 kHz and 1 MHz.

In one embodiment, the energy storage system further comprises a converter control unit controlling a plurality of control signals, each of the control signals controlling operation of a corresponding one of the switching elements.

In another embodiment, the energy storage system further comprises a three-phase dual switching frequency hybrid power converter for a three-phase load, the three-phase power converter comprising a first, a second and a third dual switching frequency hybrid power converter as previously defined, each being operatively connected to a corresponding phase of the three-phase loads.

In one embodiment, the energy storage system further comprises a system for decoupling a rotor from a stator of the permanent magnet motor-generator comprising a displacement mechanism operatively connected to a selected one of the stator and the rotor for displacing the selected one of the stator and the rotor between a first position wherein the stator extends around the rotor and a second position wherein the stator extends away from the rotor and is decoupled from the rotor; actuating means operatively coupled to the displacement mechanism for actuating the displacement mechanism; and a decoupling control unit for controlling the actuating means; wherein a relative displacement of the stator away from the rotor enables a rotational speed of the permanent magnet motor-generator greater than a base speed thereof.

In one embodiment, the displacement mechanism is connected to the stator for displacing the stator.

In another embodiment, the displacement mechanism is connected to the rotor for displacing the rotor.

In one embodiment, the displacement mechanism enables a continuous motion of the selected one of the stator and the rotor between the first position and the second position.

In one embodiment, the stator and the rotor have no magnetic interaction when extending in the second position, to thereby reduce magnetic losses in the permanent magnet motor-generator.

In one embodiment, the actuating means is selected from a group consisting of a servomotor, a pneumatic actuator and an hydraulic actuator.

In one embodiment, the decoupling control unit comprises a servomotor controller.

In a further embodiment, the energy storage system further comprises a speed sensor for sensing the rotational speed of the permanent magnet motor, the control unit controlling the relative displacement of the stator away from the rotor according to the sensed rotational speed of the permanent magnet motor.

In still a further embodiment, the energy storage system further comprises a position sensor for sensing a relative position of the stator with respect to the rotor.

In one embodiment, the displacement mechanism is connected to the stator for displacing the stator, the displacement mechanism comprising a casing connected to the stator, the casing comprising a first threaded hole and a second threaded hole longitudinally extending therethrough, the displacement mechanism further comprising a first lead screw and a second lead screw adapted for extending in a corresponding one of the first and second holes, the actuating means comprising a first and a second servomotor, each being operatively connected to a respective one of the first and second lead screws for moving the casing therealong, thereby moving the stator between the first position and the second position.

In one embodiment, the permanent magnet motor-generator is adapted to supply a constant power over a given large rotational speed range adapted to an operating rotational speed range of the flywheel.

In one embodiment, the flywheel device is mounted on a disc shaft operatively coupled to the rotating shaft of the motor assembly via a coupling mechanism, the energy storage system further comprising an additional displacement mechanism for displacing a selected one of the rotating shaft and the disc shaft away from the remaining one of the rotating shaft and the disc shaft to prevent interaction therebetween.

In a further embodiment, the coupling mechanism comprises a magnetic clutch.

In one embodiment, the system is adapted for operatively coupling the rotating shaft to at least one additional flywheel device.

In one embodiment, the rotor extends around the stator and the flywheel device extends around the rotor, the system further comprising a coupling element for operatively coupling the rotor and the flywheel device together, the coupling element comprising a plurality of magnets mounted on an inner surface of the flywheel device.

In one embodiment, the control unit is adapted for automatically storing energy during predetermined typical off-hour periods.

According to another aspect, there is also provided the use of the energy storage system as previously defined, for storing the kinetic energy over a 24 hours period.

According to another aspect, there is also provided the use of the energy storage system as previously defined, for storing the kinetic energy during a plurality of hours.

According to another aspect, there is also provided the use of the energy storage system as previously defined, for stabilizing fluctuation of the network.

According to another aspect, there is also provided the use of the energy storage system as previously defined, for recharging an electrical battery in a given period of time.

According to another aspect, there is also provided the use of the energy storage system as previously defined, for recharging an electrical battery in a given period of time ranging from 1 minute to 10 minutes.

According to another aspect, there is also provided a method of doing business in using the energy storage system as previously defined, the method comprising storing electric energy during off-hours peak consumption periods; and restituting the stored energy during peak consumption periods.

In one embodiment, the using is done by a third party.

According to another aspect, there is also provided a method of doing business in using the energy storage system as previously defined, the method comprising providing by a provider an energy storage system as previously defined to a third party; operating the energy storage system wherein the operating is done by a third party for a fee; and reconveying by the third party a portion of the fee to the provider.

The energy storage system may be useful to support the electric grid for load leveling, peak shaving, voltage and frequency regulation, renewable energy integration and for other applications where constant or variable power is necessary, which is of great advantage.

The energy storage system may also be useful in charging infrastructure for full electric vehicles or plug-in hybrid electric vehicles at a constant rate, which is of great advantage.

Moreover, the energy storage system may be of particular interest in applications where a great quantity of energy is requested over a brief period of time, such as the ultra fast charging of electrical vehicles in few minutes, which is of great advantage.

Furthermore, the energy storage system may be used to provide energy storing units distributed over the whole electrical distribution network, which is of great advantage.

The energy storage system may also be useful to provide a reliable UPS (Uninterruptible Power Supply), which is of great advantage.

### BRIEF DESCRIPTION OF THE DRAWINGS

In order that the invention may be readily understood, embodiments of the invention are illustrated by way of example in the accompanying drawings.

FIG. 1 is a graph showing a typical daily profile of the power consumption on a typical electrical distribution network.

FIG. 2 is a schematic illustrating an energy storage system according to an embodiment of the invention.

FIG. 3 is a schematic illustrating another energy storage system.

FIG. 4 is a schematic illustrating another energy storage system.

FIG. 5 is a schematic illustrating another energy storage system.

FIG. 6 shows a typical flywheel storage system.

FIG. 7A is a longitudinal cross sectional view of a flywheel device of an energy storage system, according to one embodiment.

FIG. 7B is a cross sectional view of the flywheel device shown in FIG. 7A, taken along line B-B.

FIG. 8A is a longitudinal cross sectional view of another flywheel device.

FIG. 8B is a longitudinal cross sectional view of another flywheel device.

FIG. 8C is a longitudinal cross sectional view of another flywheel device.

FIG. 8D is a longitudinal cross sectional view of another flywheel device.

FIG. 8E illustrates an embodiment of a manufacturing processing step used for manufacturing the flywheel device of FIG. 8D.

FIG. 8F is a table illustrating the mechanical characteristics of two different materials.

FIG. 8G and FIG. 8H are tables illustrating the energy which may be store in a high energy density flywheel for various configurations thereof.

FIG. 8I is a table showing the volumetric energy density and the rotational speed of a flywheel device for various configurations thereof.

FIG. 9A shows the general topology of a three-phase dual switching frequency hybrid power converter of an energy storage system according to an embodiment of the invention.

FIG. 9B shows a mono-phase dual switching frequency hybrid power converter according to another embodiment of the invention.

FIG. 9C illustrated a three-phase power converter, according to another embodiment.

FIGS. 9D and 9E are tables showing the overall losses for a typical power converter and a dual switching frequency hybrid power converter, according to one embodiment.

FIG. 10A to 10C show different magnetic flux patterns in the rotor for the respective positions shown in FIG. 10D to 10F.

FIG. 10D to 10F show different relative positions of the stator and the rotor of a permanent magnet motor.

FIG. 10G shows a graphic illustrating the relationship between power, torque and speed of a permanent magnet motor of a flywheel energy storage system using a system for decoupling a rotor from a stator.

FIG. 10H is a schematics of a system for decoupling a rotor from a stator of a permanent magnet motor, the system being mounted with a flywheel device, the stator and the rotor being coupled together.

FIG. 10I is a graph illustrating the relationship between the voltage and the speed of a permanent magnet motor for different values of the magnetic flux.

FIG. 11A is a cross sectional view of a system for decoupling a rotor from a stator of a permanent magnet motor, the system being mounted with a flywheel device, the stator and the rotor being coupled together.

FIG. 11B is a cross sectional view of the system shown in FIG. 11A, the stator and the rotor being half coupled together.

FIG. 11C is a cross sectional view of the system shown in FIG. 11A, the stator and the rotor being totally decoupled from each other.

FIG. 12A is a cross sectional view of another system for decoupling a rotor from a stator of a permanent magnet motor, the system being coupled with a flywheel device, the stator and the rotor of the permanent magnet motor being coupled together.

FIG. 12B is a cross sectional view of the system shown in FIG. 12A, the system being decoupled from the flywheel device.

FIG. 13 is a cross sectional view of another flywheel device using a system for decoupling a rotor from a stator of a permanent magnet motor, the system being adapted to be coupled to a plurality of rotating flywheels.

Further details of the invention and its advantages will be apparent from the detailed description included below.

### DETAILED DESCRIPTION

In the following description of the embodiments, references to the accompanying drawings are by way of illustration of examples by which the invention may be practiced. It will be understood that other embodiments may be made without departing from the scope of the invention disclosed.

The invention relates to an energy storage system that may provide high efficiency energy storage, particularly for medium and long term energy storage applications. For example, the energy storage system may enable an energy conservation of 95% over a 24 hour period when no energy is extracted from the energy storage system. Moreover, the energy storage system may also enable a round trip efficiency, i.e. the transfer efficiency from the electrical grid to the storage system and from the storage system to the electrical grid again, of more than 85%.

As it will be more clearly understood upon reading of the present description, the energy storage system is reliable, may be maintained at a low cost and have a long service life, which is of great advantage. For example, the lifespan of the energy storage system may be over ten years. This is much greater than the lifespan of a system using lithium-ion batteries for the same operating conditions.

The skilled addressee will appreciate that the energy storage system may help to support the electric grid for load leveling, peak shaving and voltage and frequency regulation. It may also be of particular interest to help the integration of renewable energy to the existing distribution electric network and for other applications where constant or variable power is necessary.

The energy storage system may also be particularly useful in many applications such as in charging infrastructure for electric vehicles or plug-in hybrid electric vehicles at a constant rate for example, as it will be more clearly detailed thereinafter.

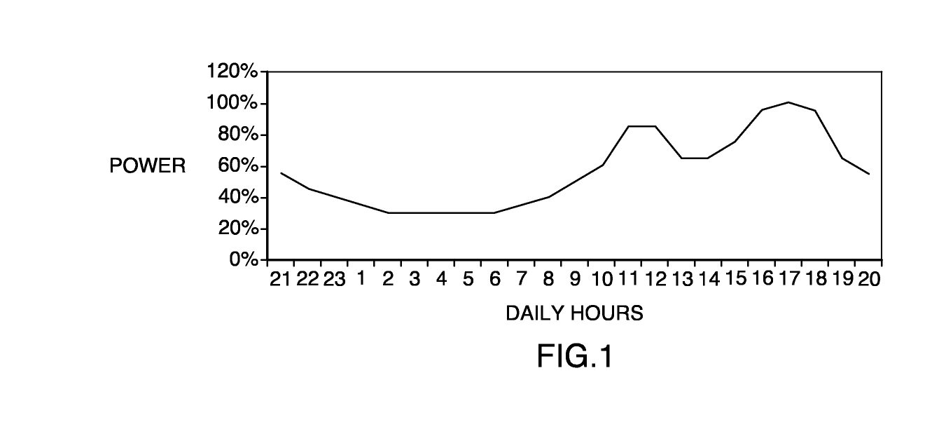

Referring to FIG. 1, there is shown a typical profile of the power consumption on a typical electrical distribution network. As known to the skilled addressee, during a typical day, there are two peaks of consumption, the one at the middle of the day at about noon and the other one during the evening. The overall energy production has thus to be planned in order to accommodate these two peaks of consumption.

During the off-peak hours, all the available energy is not consumed and the remaining energy may be stored in an energy storage system and then released on the distribution network at the appropriate moment, i.e. during the peak hours for example. The skilled addressee will appreciate that the energy storage has to be efficient enough to maintain the stored energy over several hours.

Such energy storage systems may be of particular interest for satisfying the power peaks with the power stored during the off-peak hours without to have an overall available power satisfying the power peaks, as it will become apparent upon reading of the present description.

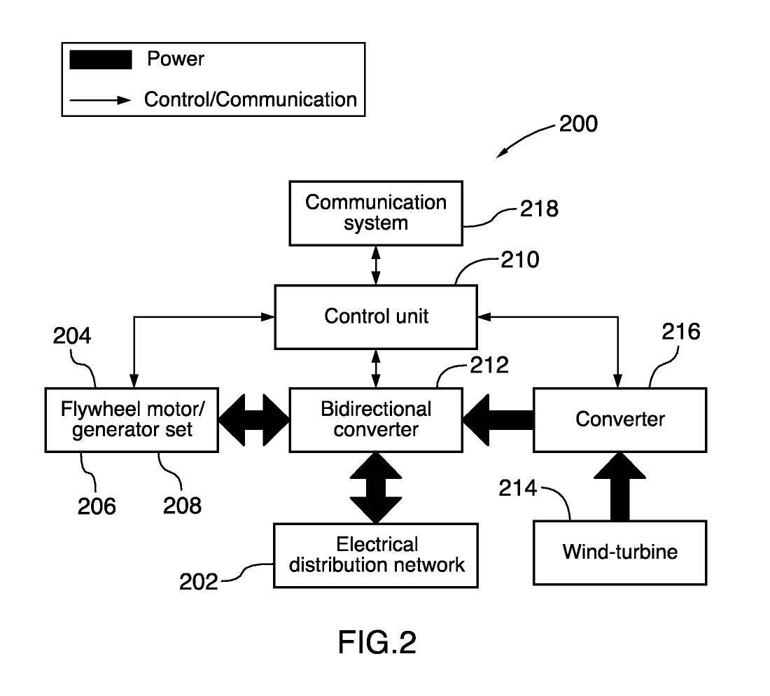

Referring now to FIG. 2, an embodiment of an energy storage system according to the invention will now be described.

In the illustrated embodiment, the energy storage system 200 is operatively connectable to an electrical distribution network 202 for storing electrical energy thereof. As it will become apparent below, in one embodiment, the energy storage system 200 is adapted to efficiently store energy over a medium term duration, i.e. several hours, or over a long term duration, i.e. up to 24 hours and more.

The energy storage system 200 comprises a motor assembly 204 operatively connectable to the electrical distribution network 202 for providing kinetic energy. In other words, as known to the skilled addressee, the motor assembly 204 is driven with electrical energy and provides an output energy under a kinetic form on a rotating shaft (not shown).

The energy storage system 200 also comprises a flywheel device 206 operatively connectable to the motor assembly 204 for storing at least one part of the kinetic energy. Indeed, as known to the skilled addressee, typical losses due to friction and the use of bearings prevent the transfer of all the available kinetic energy to the flywheel device 206.

The energy storage system 200 also comprises a generator assembly 208 operatively connectable to the flywheel device 206 for receiving at least one portion of the part of the kinetic energy and generating regenerated electrical energy in response thereto.

In one embodiment, the motor assembly 204 and the generator assembly 208 are embedded in a single apparatus adapted for acting as a motor and a generator. In one embodiment that will be described in details below, a permanent magnet motor adapted for providing a motor mode and a generator mode is used.

Still referring to FIG. 2, the energy storage system 200 comprises a control unit 210 for controlling operation of the energy storage system 200. The control unit 210 enables an energy storage operating mode wherein the motor assembly 204 is connected to the flywheel device 206 and the electrical distribution network 202 for storing the part of the kinetic energy into the flywheel device 206. The control unit 210 also enables an energy supply operating mode wherein the generator assembly 208 is connected to the flywheel device 206 and the electrical distribution network 202 for providing at least one portion of the regenerated electrical energy thereto.

In the embodiment wherein a single permanent magnet motor adapted for providing a motor mode and a generator mode is used, the skilled addressee will appreciate that the permanent magnet motor remains connected to each of the flywheel device 206 and the electrical distribution network 202. In this case, the control unit 210 controls the mode of operation, either as a generator or either as a motor, according to the needs. For example, the control unit 210 may be adapted so that the energy storage system 200 automatically stores energy during predetermined typical off-hour periods, as more detailed thereinafter.

In the illustrated embodiment, the energy storage system 200 further comprises an electronic power converter 212 operatively associated with the motor assembly 204 and the generator assembly 208. In the illustrated case, the electronic power converter 212 comprises a bidirectional converter adapted for converting the regenerated electrical energy into converted electrical energy enabling a corresponding electrical power exchange between the generator assembly 208 and the electrical distribution network 202. The power converter 212 also enables a corresponding electrical power exchange between the electrical distribution network 202 and the motor assembly 204.

Still referring to FIG. 2, in a further embodiment, the energy storage system 200 may be further connected to a stand-alone electrical energy source 214 such as a wind-turbine for a non-limitative example. In this case, a second power converter 216 may be used to convert the electrical energy supplied by the wind turbine into a converted signal adapted to the motor assembly 204.

In one embodiment, the energy storage system 200 may also comprise a communication system 218 adapted for sending data to the control unit 210 in order to remotely control the mode of operation of the energy storage system 200, as it will be more detailed thereinafter.

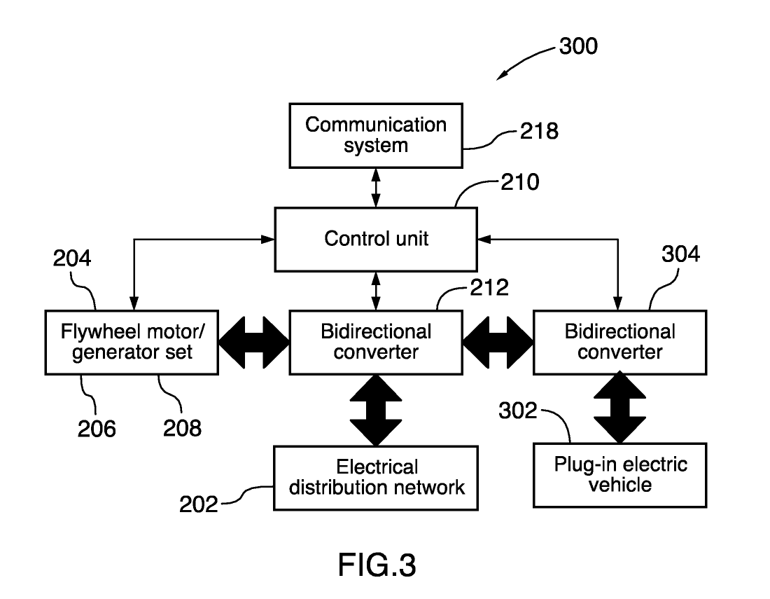

Referring now to FIG. 3, there is shown another embodiment of an energy storage system 300 that may be used for the charging of electrical or hybrid vehicles.

In the illustrated embodiment, the energy storage system 300 is still connected to the electrical distribution network 202. The energy storage system 300 is also further connected to an electrical appliance 302 via an additional power converter 304. In the illustrated case, the electrical appliance 302 comprises one electrical terminal adapted for connecting to an electrical or hybrid vehicle (not shown) for recharging the electrical or hybrid vehicle.

The skilled addressee will appreciate that the electrical appliance 302 may comprise a plurality of electrical terminals. This embodiment may be particularly useful in a station for recharging electrical or hybrid vehicles, similarly to a typical gas station.

In the illustrated case, the additional converter 304 is connected to the generator assembly 208 via the bidirectional converter 212 but the skilled addressee will appreciate that various other embodiments may be considered. For example, the additional converter 304 may be directly connected to the generator assembly 208.

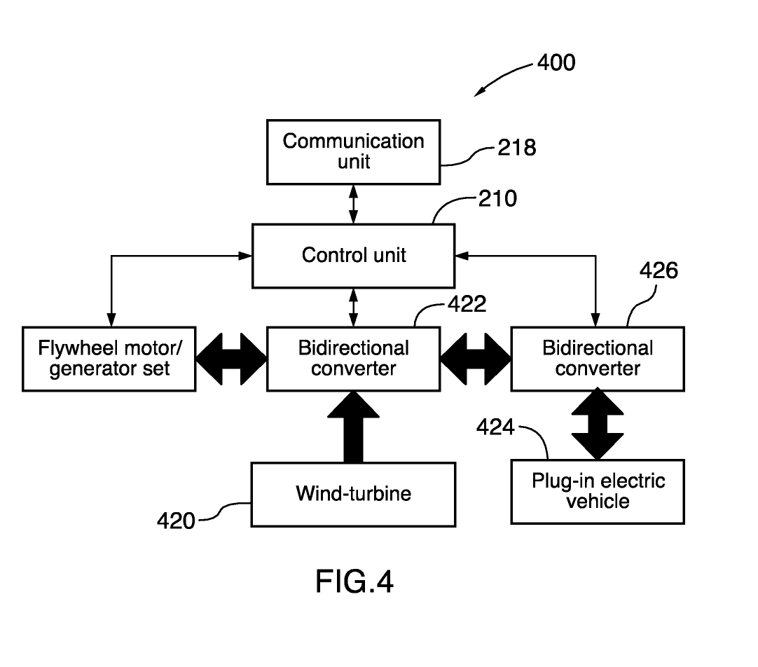

Referring now to FIG. 4, another embodiment of an energy storage system 400 according to the invention is illustrated. In this embodiment, the energy storage system 400 provides a stand-alone configuration since it is not connected to the electrical distribution network. Indeed, the energy storage system 400 is connected to a wind turbine 420 acting as an electrical source of energy via a power converter 422. The energy storage system 400 is also connected to an electrical terminal 424 adapted for connecting to an electrical or hybrid vehicle (not shown) for recharging the electrical or hybrid vehicle. In the illustrated embodiment, a power converter 426 is used to convert the electrical power into converted electrical energy adapted to the vehicle.

The skilled addressee will appreciate that this embodiment may be particularly useful for providing an autonomous recharging station for recharging electrical or hybrid vehicles which is totally independent of the electrical distribution network. Indeed, this embodiment may be provided with a plurality of wind turbines or even a combination of different renewable energy sources comprising wind turbines, solar panels or geothermal sources as non-limitative examples, and installed in places where no distribution electrical network is readily available.

The skilled addressee will also appreciate that the energy storage system 400 may be used as an autonomous energy reserve for various other applications.

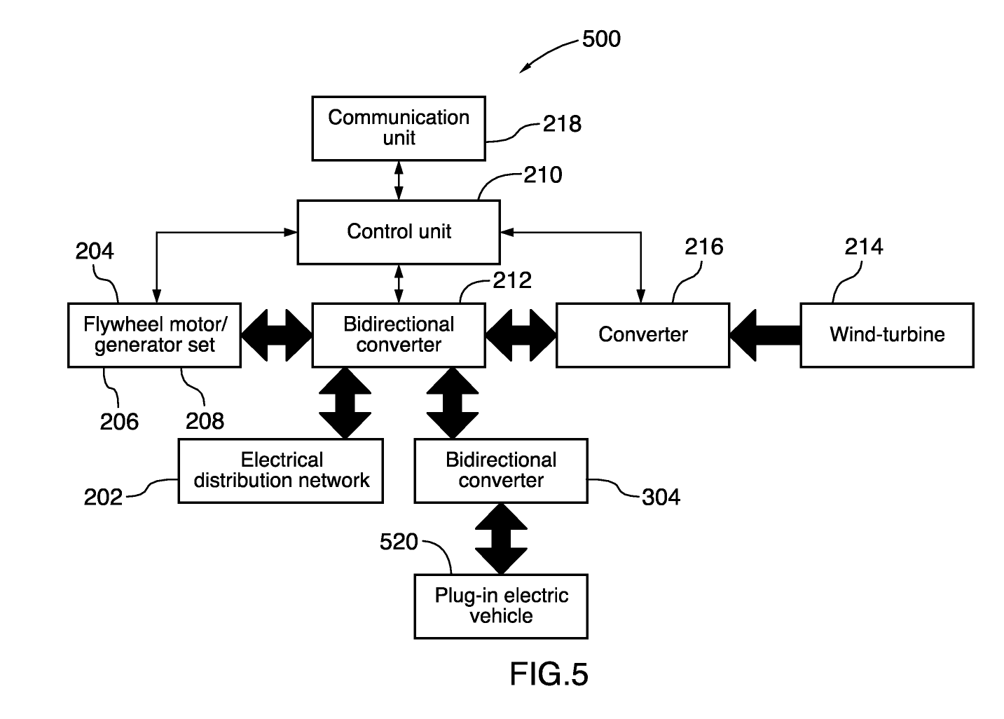

Referring now to FIG. 5, there is shown another energy storage system 500 according to another embodiment. The energy storage system 500 is connectable to a wind turbine 214, as in the embodiment shown in FIG. 2, and is also connectable to an electrical terminal 520 adapted for connecting to an electrical or hybrid vehicle (not shown) for recharging the electrical or hybrid vehicle, as in the embodiment shown in FIG. 3. In this embodiment, three power converters 212, 216 and 304 interconnected together are used for converting the input or output electrical power into a converted signal enabling a corresponding electrical power exchange between the corresponding elements.

In the illustrated embodiment, the power converter 212 is a bidirectional power converter operatively connected between the generator and motor assemblies 204, 208 and the electrical distribution network 202. The power converter 212 is also connected to the power converters 216 and 304. The skilled addressee will nevertheless appreciate that other arrangements may be considered, as long as they enable a suitable power exchange between the corresponding elements.

Referring now to FIG. 6 which illustrates a typical flywheel device 600, the skilled addressee will appreciate that the flywheel device of the energy storage system may comprise any typical flywheel.

In one embodiment, the flywheel device comprises a high energy density flywheel such as the one described in related PCT application entitled “High power density flywheel”, filed on Jun. 15, 2010, the specification of which is hereby incorporated by reference.

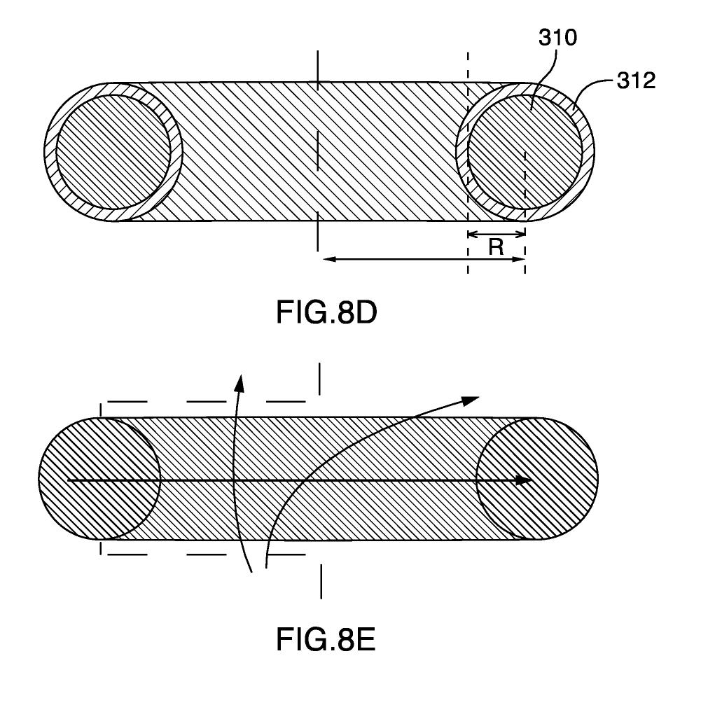

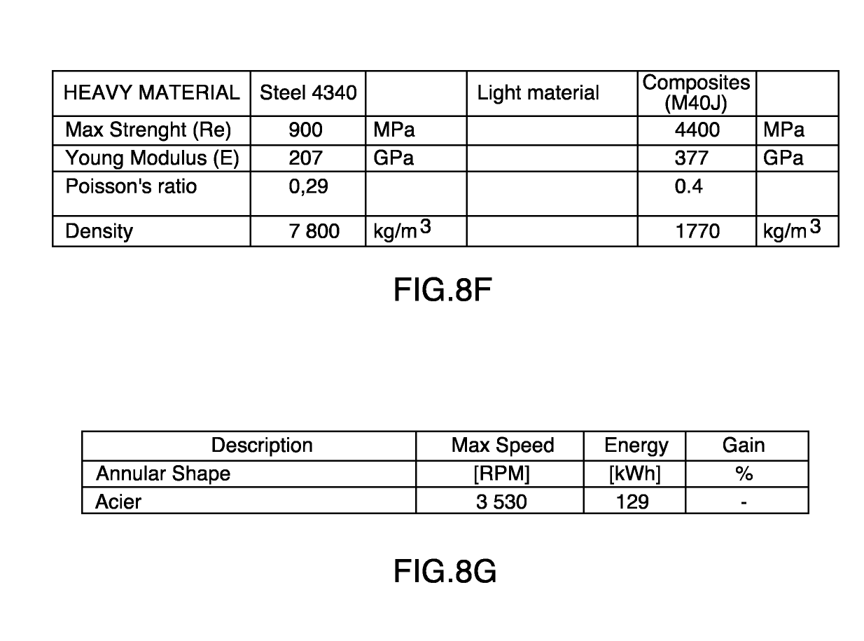

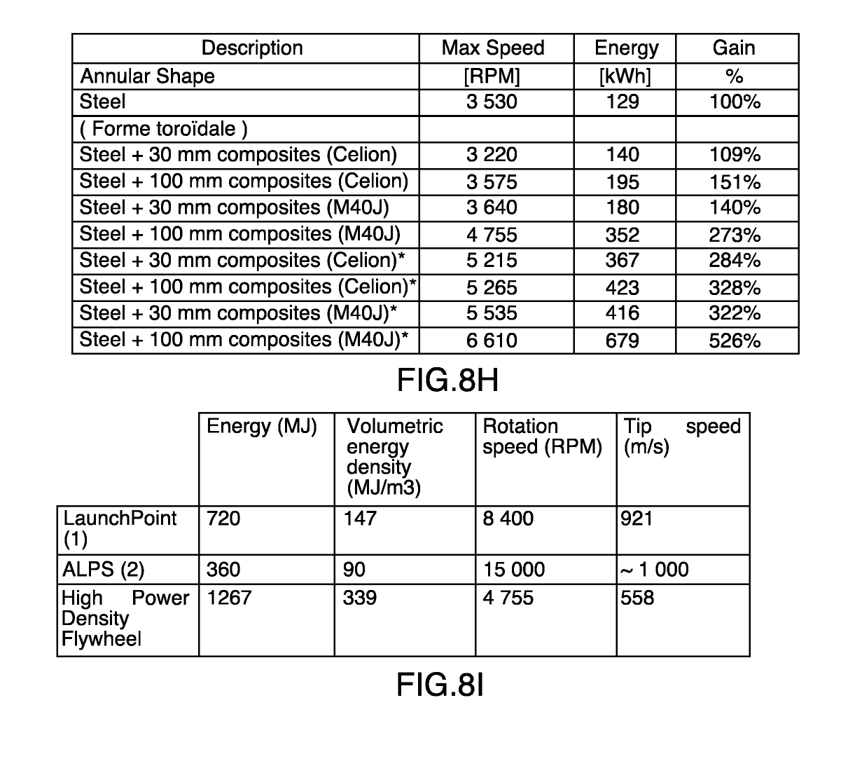

Now referring to FIG. 7A to FIG. 8E, various embodiments of a high power density flywheel as described in the above mentioned provisional application are shown.

In one embodiment, as previously mentioned, the high power energy flywheel 700 is devised to be mounted on a rotating shaft 702 driven by a motor assembly for storing kinetic energy therein.

In the embodiment illustrated in FIG. 7A and FIG. 7B, the high power density flywheel 700 comprises an inner hub 704 fixedly mounted to a rotating shaft 702 via a first coupling 706 and a second coupling 708.

The illustrated high power density flywheel 700 comprises a first member 710 to be operatively mounted on the rotating shaft 702. The first member 710 comprises a first material having a high mass density enabling a high kinetic energy storage capacity. In one embodiment, the first material also has a low maximal yield strength, i.e 10 to 500 MPa as a non-limitative example. In the illustrated embodiment, the first member 710 comprises a single piece of the first material having a crown shape. The first material may be selected from a group consisting of steel, lead, tungsten and any combination thereof presenting the characteristics mentioned above.

The high power density flywheel 700 also comprises a second member 712 operatively attached to the first member 710 and surrounding an outside portion 714 of the first member 710 subject to radial forces generated by a rotation of the flywheel 700. In the illustrated case, the second member 712 is fixedly attached to the inner hub 704 and encloses totally the first member 710. Glue or any other suitable attaching means may be used to fixedly attach the second member 712, the inner tube 704 and the first member 710 together.

The second member 712 comprises a second material having a high maximal yield stress greater than the low yield stress of the first member 710 enabling a high maximum rotational speed. In one embodiment, the second member 712 also has a low mass density. The second material may be selected from a group consisting of carbon, Kevlar and any composite material presenting the characteristics mentioned above. A combination of different types of such material may also be considered in an alternative embodiment.

The second member 712 enables an operation of the high power density flywheel 700 at a flywheel rotational speed greater than the low maximum rotational speed permitted by the low elastic constraint of the first material, to thereby provide the flywheel with a high kinetic energy storage capacity.

Indeed, as an illustrative example, with a conventional typical flywheel, a storage capacity of 1000 MJ/m³ may be reached with a flywheel rotational speed of 30 000 rpm. In one embodiment of the present invention, a similar storage capacity of 1000 MJ/m³ may also be reached, but at a much lower rotational speed of the flywheel, 5 000 rpm for example, which is of great advantage.

The skilled addressee will appreciate that this embodiment enables to combine the advantages of each type of a single material flywheel, which is of great advantage. Indeed, the above described flywheel enables a high power storage capacity in the first member 710, thanks to its particular properties described above, while allowing a higher rotational speed than the one permitted in the case where no second member 712 is used, as it will more clearly detailed thereinafter.

As mentioned above, in the illustrated embodiment, the second member 712 fully encloses the first member 710 but it will be appreciated by the skilled addressee that various other arrangements may be considered alternatively. For example, the second member 712 may only extend on the outside portion 714 of the first member 710 subject to radial forces generated by a rotation of the flywheel 700, like a radial belt. In another embodiment, the first member 710 may be in direct contact with the inner hub 704. In still another embodiment, the flywheel 700 may be provided without the inner hub 704 and the first element 710 may be directly attached to the shaft 702. The skilled addressee will nevertheless appreciate that, in one embodiment, it is advantageous to mount the heavy weight away of the rotating shaft 702 to maximize the energy storage capacity.

The skilled addressee will also appreciate that in one embodiment, the weight of the first element is evenly distributed around the shaft 702. This evenly distributed weight may contribute to the stability of the flywheel 700 when in rotation, particularly at a high rotational speed. This distributed weight may also help minimizing the friction between the shaft 702 and the supporting bearings (not shown) in order to minimize the overall losses of the energy storage system. Moreover, it may also help reducing the weight of the overall energy storage system since the bearings will not have to be over-sized.

The skilled addressee will appreciate that a high power density flywheel such as the one described therein enables to store a great quantity of kinetic energy while minimizing the energetic losses therein. The skilled addressee will also appreciate that, since the speed of rotation of the flywheel and the mass thereof are relatively high, the storage duration of the stored kinetic energy is also improved, thanks to the inertia of the flywheel. In one embodiment, the speed of rotation of the flywheel is comprises between 5 000 rpm and 10 000 rpm but the skilled addressee will appreciate that other speeds of rotation may be chosen according to a particular application.

From the above, the skilled addressee will appreciate that the high power density flywheel as described above, even if adapted for short term applications, may be particularly useful for medium and long term applications where energy has to be stored for several hours.

In the illustrating drawings, the flywheel has been described as being adapted to be mounted on a rotating shaft but the skilled addressee will appreciate that other arrangements may be considered. For example, the flywheel may be hold by levitation thanks to magnetic supports.

FIG. 8A to 8E show other embodiments of a high power density flywheel 800 that may be alternatively used.

In order to further minimize deformation of the first material, a toroidal configuration as illustrated in FIG. 8D may be used. As illustrated, the first member 310 has a toroidal shape and the second member 312 has an empty toroidal shape wholly enclosing the first member 310.

In one embodiment, the second member comprises at least three covers or layers, each being wound on the first member 310. These covers or layers may comprise composite sheets or composite fibers wound with a synthetic resin, as known in the art.

In a further embodiment, each of the three covers is wound on the first member 310 according to a respective principal direction thereof, as shown in FIG. 8E. In other words, a first one of the three covers is axially wound on the first member, a second one of the three covers is circumferentially wound on the first member and a third one of the three covers is wound at 45 degrees with respect to the first one of the three covers. The skilled addressee will appreciate that winding techniques typically used in the art of winding material may be adapted to the composite material used therein. The skilled addressee will also appreciate that various other arrangements may be used to provide a toroidal flywheel as described above.

Referring now to FIG. 8D and also to FIG. 8H, theoretical results will be presented for an embodiment of a high energy density flywheel as illustrated in FIG. 8D, that is a toroidal high energy density flywheel. The first member has an inner diameter of 1.66 meter and a radius of 0.3 meter. The skilled addressee will appreciate that the thickness of the second member may be varied.

The second member which is made of a composite material and totally encloses the first member retains and maintains the first member during the rotation in each direction, thereby minimizing even more deformations of the first material. Thus, the high energy density flywheel may be operated at a higher rotational speed than a typical heavy flywheel not equipped with a second member. It may also be operated at a higher rotational speed than the rotational speed allowed with the annular configuration wherein the second material extends on the radial outer portion only.

FIG. 8H shows the maximal rotational speed that may be attained with various configurations of a toroidal high energy density flywheel as shown in FIG. 8D. The four last results, i.e. those presented with an asterisk, have been obtained using the maximal yield strength of the second material, while the other results have been obtained using the maximal yield strength of the first material for obtaining the maximal allowed rotational speed. The results show that for most of the configurations, a higher rotational speed than the one obtained with the annular configuration may be obtained. The skilled addressee will appreciate that the quantity of energy that may be store in the high energy density flywheel may be greatly improved with the toroidal configuration using the first material and the second material. The column of the right of the table shows in percent, the gain that may be attained with respect to the annular configuration discussed above.

The skilled addressee will appreciate that the toroidal configuration of a high energy density flywheel presented above is of great advantage since it enables to store a greater quantity of energy with respect to the configuration of the prior art, while using a lower rotational speed. The lower rotational speed further enables to minimize the aerodynamics losses and the losses due to the bearings, thereby enabling a longer storage of the energy.

FIG. 8I shows technical characteristics for various types of flywheel. The two first types presented are composite flywheels of the art respectively proposed by the company LaunchPoint and the research group ALPS while the third one is a toroidal high energy density flywheel using a first material and a second material. The composite flywheels should be operated at a high rotational speed since their mass is low. At a high rotational speed, the speed at the tip is also high, thus causing aerodynamics losses.

FIG. 8I clearly shows that the use of a toroidal high energy density flywheel using a first material and a second material is of great advantage. Indeed, the flywheel has a high energy density 2.3 higher in the example presented above than the conventional flywheels, while rotating at a lower rotational speed, thereby storing the energy on a longer period of time since the losses are reduced.

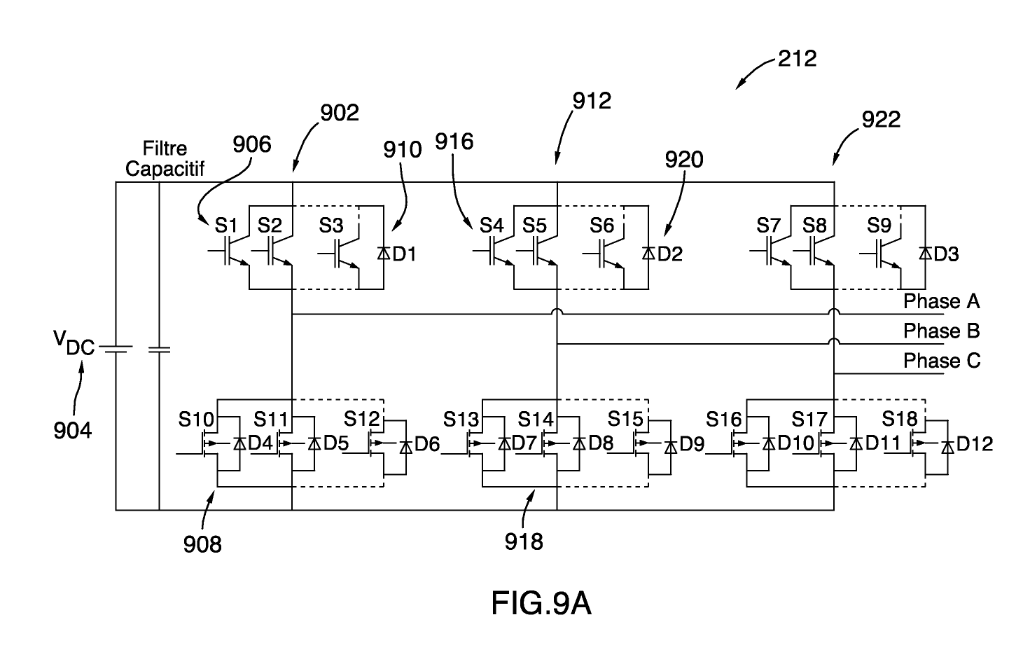

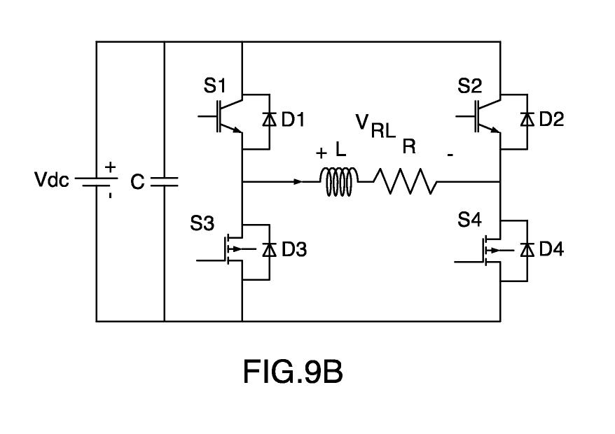

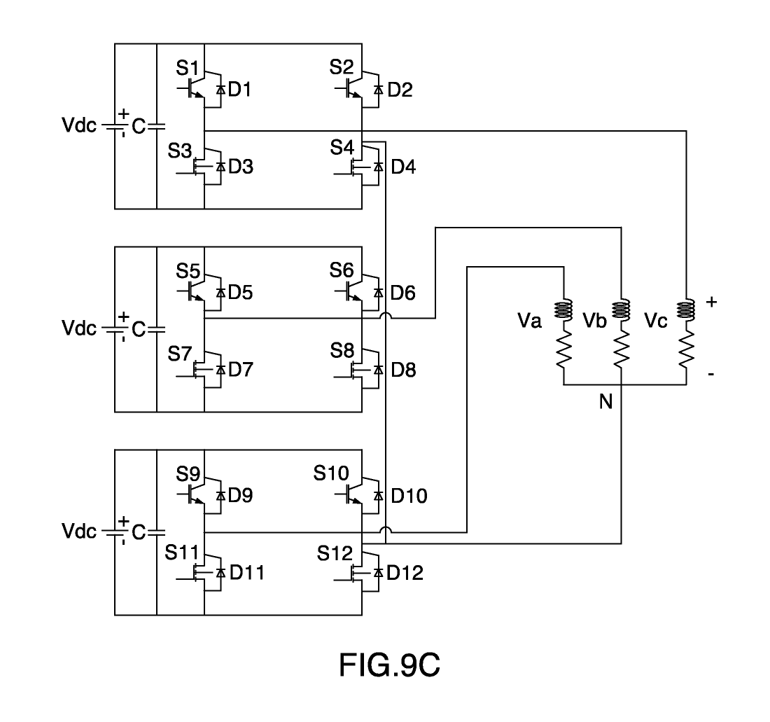

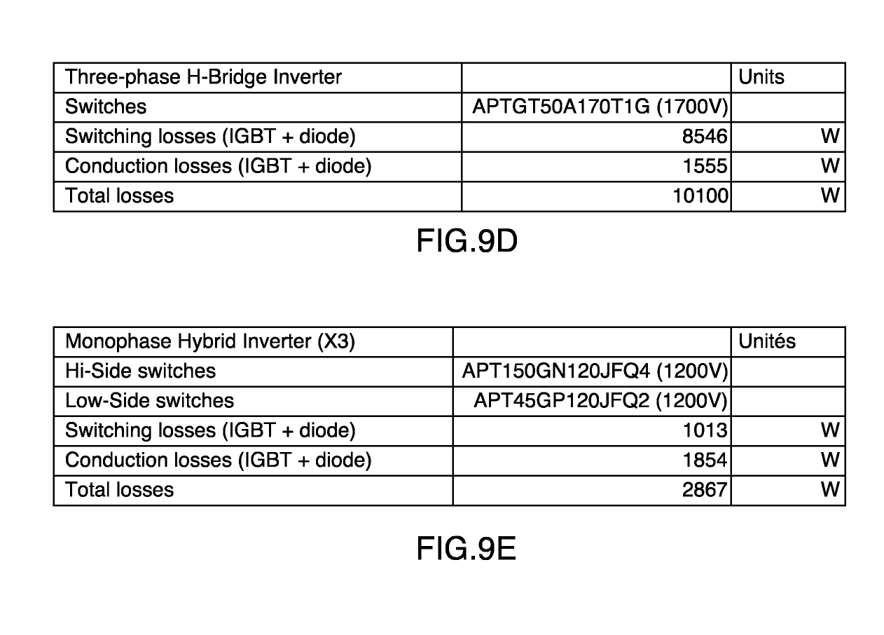

Referring now to FIG. 9A, in one embodiment, the power converter 212 (shown in FIG. 2) may comprise a dual switching frequency hybrid power converter as the one described in PCT Application entitled “Dual switching frequency hybrid power converter” and filed on Jun. 15, 2010, the specification of which is hereby incorporated by reference.

As described in this provisional patent application, the disclosed power converter uses two different types of switching elements, each type of switching element being used in an optimal configuration to reduce the overall output losses of the power converter.

Indeed, the power converters of the prior art generally use a single type of switching elements for effecting the power conversion. Switching elements presenting low conduction losses such as the IGBTs however present a low commutation speed and high commutation losses. On the other hand, switching elements presenting low commutation losses such as the MOSFETs however present high conduction losses.

Moreover, as known to the skilled addressee, each of the IGBT and the MOSFET may be provided with an integrated anti-parallel diode. While the diode integrated to an IGBT generally presents a fast operating speed, the diode integrated to a MOSFET has a much more lower operating speed.

The three-phase dual switching frequency hybrid power converter shown in FIG. 9A uses two different types of switching elements: a first switching element having low conduction losses such as an IGBT and a second switching element having low commutation losses such as a MOSFET. A fast IGBT may also be considered for the second switching element.

As it will be more clearly detailed below, the MOSFETs are switched at a high frequency since they are fast and present low commutation losses while the IGBTs are switched at a low frequency since they are much slower. Moreover, in order to reduce even more the overall losses of the converter, the IGBTs, which have low conduction losses, are used more often than the MOSFETs.

Moreover, the anti-parallel diodes that are generally integrated to the MOSFETs may not be used at a high switching frequency, which is of great advantage since they are slow and dissipative when switched at a high frequency. As detailed in the above-mentioned provisional patent application, the described topology becomes even more advantageous when a plurality of MOSFETs is connected in a parallel relationship to provide more current power.

The skilled addressee will appreciate that this particular arrangement enables to greatly reduce the output losses of the converter while providing a high switching frequency. This high switching frequency enables to reduce the size of the passive components (the capacity and the inductor) and the overall cost of the converter, which is of great advantage, particularly in the case where the power converter is provided on a printed circuit board.

As shown in FIG. 9A, the dual switching frequency hybrid power converter is adapted to be connected between a DC element and an AC element for voltage conversion. In the illustrated case, the converter is used for converting a DC voltage to an AC voltage but it should be understood that conversion from an AC source to a DC source may also be performed. An AC to AC voltage conversion may also be performed, as well as a DC to DC voltage conversion, according to a particular application.

The dual switching frequency hybrid power converter 212 comprises a first leg 902 electrically connected to the DC element 904, a DC power source in the illustrated case. The first leg 902 comprises a high side switch device 906 and a low side switch device 908 serially connected. The high side switch device 906 comprises a plurality of a selected one of a first switching element having low conduction losses and a second switching element having low commutation losses, the plurality of switching element being connected in a parallel relationship. In the illustrated embodiment, the high side switch device 906 comprises three IGBTs.

The low side switch device 908 comprises a plurality of the remaining of a first switching element having low conduction losses and a second switching element having low commutation losses. In the illustrated case, the low side switch device 908 comprises three MOSFETs connected in a parallel relationship with each others.

The first leg 902 further comprises an anti-parallel diode 910 operatively connected in a parallel relationship with the three IGBTs. In one embodiment, the anti-parallel diode 910 may be integrated to the IGBT but the skilled addressee will appreciate that a diode not integrated with the IGBT may be alternatively used.

The dual switching frequency hybrid power converter 212 comprises a second leg 912 electrically connected to the DC source 904 in a parallel relationship with the first leg 902. The second leg 912 comprises a high side switch device 916 and a low side switch device 918 serially connected. The high side switch device 916 comprises a plurality of a selected one of a first switching element having low conduction losses and a second switching element having low commutation losses corresponding to the one selected for the high side switch device 906 of the first leg 902. In the illustrated case, the high side switch device 916 of the second leg 912 comprises three IGBTs.

The low side switch device 918 of the second leg 912 comprises a plurality of the remaining of a first switching element having low conduction losses and a second switching element having low commutation losses. In the illustrated case, the low side switch device 918 of the second leg 912 comprises three MOSFETs.

The second leg 912 further comprises an anti-parallel diode 920 operatively connected in a parallel relationship with the IGBTs. In one embodiment, the anti-parallel diode 920 may be integrated to the IGBT but the skilled addressee will appreciate that a diode not integrated with the IGBT may be used.

The dual switching frequency hybrid power converter 212 also comprises a third leg 922 electrically connected to the DC source 204 in a parallel relationship with the first and second legs 902, 912. As illustrated, the third leg 922 is similar to the first and second legs 902, 912.

As more clearly detailed in the previously mentioned PCT application entitled “Dual switching frequency hybrid power converter”, each of the first switching elements is operated at a low fundamental frequency and each of the second switching elements is operated at a high frequency greater than the low fundamental frequency.

In one embodiment, the low fundamental frequency is comprised between 1 Hz and 1000 Hz. In a further embodiment, the low fundamental frequency is 60 Hz while in another embodiment, the low fundamental frequency is 50 Hz.

In one embodiment, the high frequency is comprised between 1 kHz and 1 MHz although greater values may also be considered for a given application.

The skilled addressee will appreciate that various arrangements may be envisaged for the low fundamental frequency and the high frequency, as long as the two frequencies are distinct enough.

The skilled addressee will appreciate that the described operating sequence enables to not use the diode of the MOSFETs at a high switching frequency, which if of great advantage for reducing output losses of the power converter.

The above-described topology of a converter has been tested and has shown that the overall losses of the converter may be reduced by a factor 4 when using a switching frequency of 20 kHz. The tests also show that the overall losses may be even more reduced when using a switching frequency of 200 kHz.

FIG. 9B shows an embodiment of a monophase power converter. According to the principle of the invention, when the voltage and the current across the load are both positive, S1, S4 and D2 are activated, S4 enables the modulation. When S4 is stopped, D2 becomes active and enables a free wheel operation therethrough. When the voltage and the current across the load are both positive, S2, S3 and D1 are activated, S3 enables the modulation. When S3 is stopped, D1 becomes active and enables a free wheel operation therethrough.

In the case where the load is a capacitive load or an inductive load, there is a phase difference between the voltage and the current across the load. The operating sequence of the power converter should be adapted to this particular case.

Indeed, when the voltage becomes negative but the current is still positive, S1 and S4 stop. Because of the voltage across the load, D2 and D3 conduct. Since D2 and D3 conduct, S2 and S3 cannot be activated and the operating sequence for converting the voltage cannot be performed.

Similarly, when the voltage becomes positive but the current is still negative, D1 and D4 conduct and prevent the activation of S1 and S4. In this case, one can not modulate the voltage of the load in order to provide a sinusoidal current. Indeed, as illustrated in FIG. 30, this phenomenon will create a distortion of the current, which is unacceptable for given applications.

In order to overcome this issue, D1 and D2 may be blocked to prevent their conduction according to a given sequence. This enables a sinusoidal modulation of the current, which is of great advantage.

For example, in one embodiment, when the voltage becomes negative but the current is still positive, S4 is triggered in order to block D2. If D2 and D3 conduct, the current decreases linearly in a fast manner. On the contrary, when S4 is triggered, D2 becomes blocked and the current across the load still decreases, but more slowly. Thus, it becomes possible to modulate the current across the load with the control signals controlling S4. In this manner, a sinusoidal current may be obtained.

In this embodiment, the control signal controlling S4 is similar to the inverted control signal controlling S3, as previously detailed for the case of a resistive load.

Referring now to FIG. 9C, there is shown another embodiment of a three-phase dual switching frequency hybrid power converter for a three-phase load. The three-phase power converter comprises a first, a second and a third dual switching frequency hybrid power converter as previously defined. Each of the first, second and third power converter is operatively connected to a corresponding phase of the three-phase load. Although three DC power sources are shown, it should be mentioned that a single DC power source may be used. The neutral conductor of the load is operatively connected to each of the three power converter, as illustrated.

The embodiment shown in FIG. 9C is of great advantage with respect to the typical power converters of the art. Indeed, with this embodiment, the required DC voltage may be lower than in the case of a typical power converter in order to generate a given output voltage. For example, a DC voltage of 490V is required to generate an output voltage of 347V between one of the phases and the neutral conductor. With a three-phase power converter of the prior art having three legs, a DC voltage of 848V is required in order to provide the same output voltage of 347V.

The above disclosed embodiment is of great advantage since it enables to greatly reduce the overall losses of the power converter. Indeed, the required switching elements may have a reduced size since they are adapted for a reduced voltage. These switching elements may thus be faster, thereby reducing the losses associated to the commutation time. Moreover, since the DC voltage is reduced, the commutation losses may also be reduced.

FIGS. 9D and 9E show the overall losses simulated for a power converter according to the invention and a typical power converter respectively. The simulation has been made for an output power of 200 kW with a power factor of 0.8, a voltage of 347 V between a phase and the neutral conductor and a current of 240 Arms with a DC power source of 570 V.

With a typical power converter, there are three IGBTs mounted in parallel for each switching element, for a total of 18 IGBTs. The used switching frequency is 20 kHz. FIG. 9D shows the losses. The switching elements have a reduced speed since they are adapted for a high voltage, i.e. the DC bus is at 1000 V. This increases the losses.

FIG. 9E shows the losses with a three phase power converter comprising three mono-phase power converter according to the invention. The high-side switches are operated at a low fundamental frequency of 60 Hz. Each mono-phase power converter comprises 12 IGBTs, thus the three-phase power converter comprises 36 IGBTs.

The switching elements have been chosen to support two times the voltage of the DC source. One can see that the commutation losses are greatly lowered with respect to the typical power converter, which is of great advantage.

The conduction losses are however greater since more switching elements conduct at the same time. The skilled addressee will nevertheless appreciate that the overall losses are reduced by a factor of 3.5 with respect to a typical power converter.

The skilled addressee will appreciate that the dual switching frequency hybrid power converter as previously defined may be used for converting an AC voltage into a DC voltage or for converting a DC voltage into an AC voltage or even for converting an AC voltage into another AC voltage. As previously mentioned, a conversion from a DC voltage to another DC voltage may also be considered. The conversion is done between a first element and a second element. The first element and the second element being a DC voltage source and a DC load.

Embodiments of the dual switching frequency hybrid power converter have been described with IGBTs as the first switching elements and MOSFETs as the second switching elements but the skilled addressee will appreciate that other arrangements may be considered, as long as the first switching elements have suitable low conduction losses and the second switching elements have suitable low commutation losses. For non-limitative examples, thyristors, GTO, IGCT, MCT or specific types of MOSFETS presenting low conduction losses may be used for the first switching elements. Moreover, specific fast IGBTs may be used for the second switching elements.

As previously mentioned, in one embodiment, the motor assembly and the generator assembly are embedded in a single apparatus adapted for acting as a motor and a generator. In one embodiment, a permanent magnet motor adapted for providing a motor mode and a generator mode is used.

As known to the skilled addressee, the range of speed in which a permanent magnet motor is able to provide a constant power is very limited.

In order to increase the range of speed on which constant power may be provided, a system for decoupling a rotor from a stator of a permanent magnet motor as the one described in PCT Application entitled “System for decoupling a rotor from a stator of a permanent magnet motor and flywheel storage system using the same”, filed on Jun. 15, 2010, the specification of which is hereby incorporated by reference, may be used. This system enables to fully decouple the rotor from the stator of the motor in order to cancel the losses during a conservative mode, which is of great advantage as detailed below.

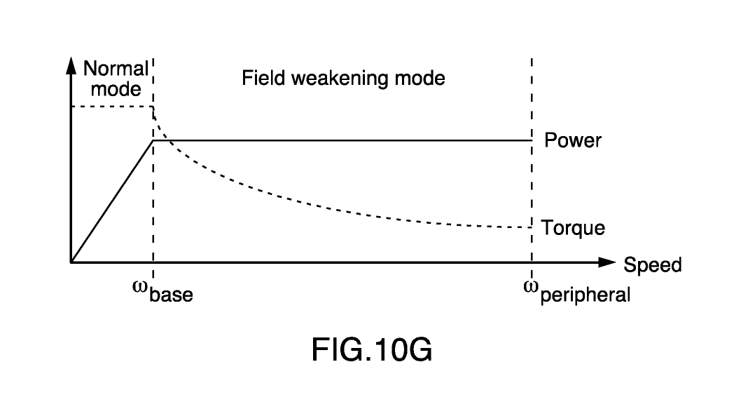

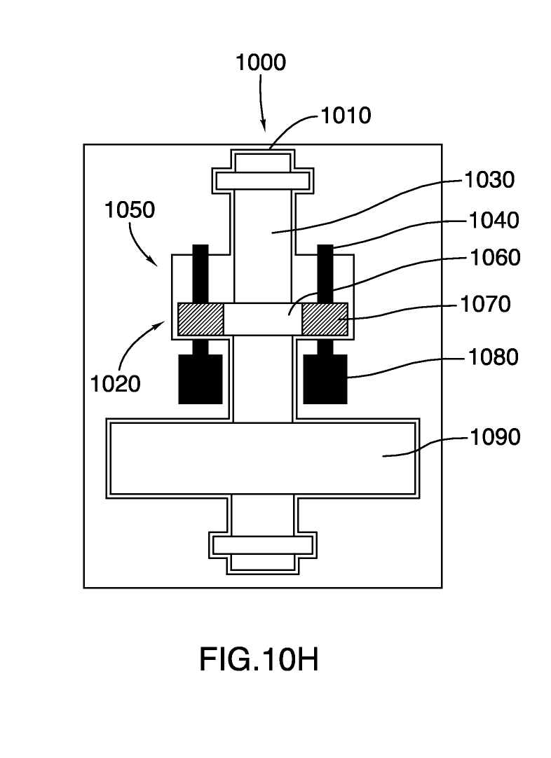

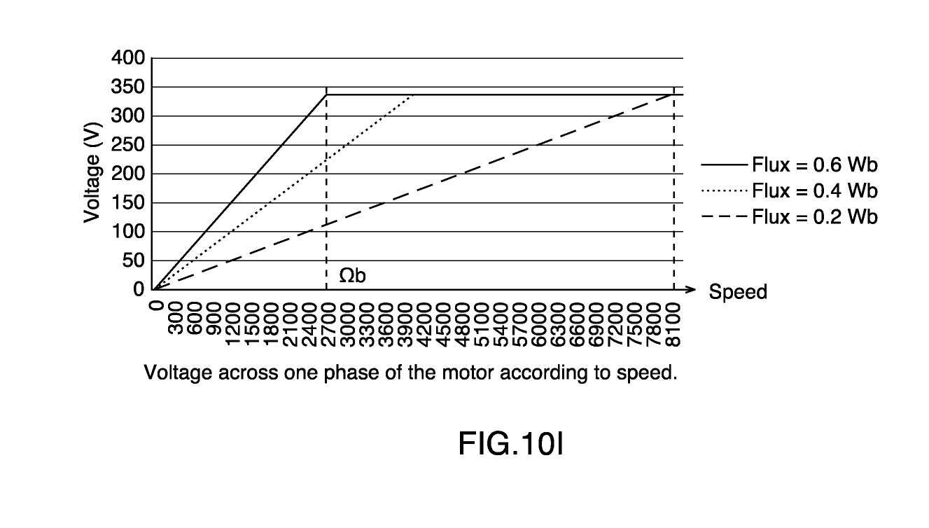

FIG. 10G is a graph illustrating the relationship between power, torque and speed of a permanent magnet motor using a decoupling system. FIG. 10A to 10F illustrate the general principles of the system for decoupling a rotor from a stator of a permanent magnet motor. As illustrated, the displacement of the stator from the rotor magnet creates various magnetic flux patterns in the coils of the motor.

FIG. 10A and FIG. 10D, the normal mode of operation of a permanent magnet motor-generator is shown. In this normal mode of operation, the rotor and the stator of the permanent magnet motor are totally coupled together. The available output power is proportional to the speed of rotation of the motor between 0 rpm and the base speed. In other words, the power that the motor can absorb to rotate the disc of the flywheel coupled thereto or the power that the motor can supply from the inertia of the disc varies linearly. In this range, the motor is able to provide a constant torque.

In FIG. 10B and FIG. 10E, the field weakening mode of operation of a permanent magnet motor-generator using a decoupling system is shown. This mode of operation is comprised between the base speed and a maximal flywheel speed defined by the maximal elastic constrain of the material of the rotating disc. For a flywheel allowing a suitable high rotational speed, this maximal flywheel speed may be above the maximal speed allowed by the same motor-generator not equipped with a decoupling system.

In this particular mode, as the speed increases, a control unit of the decoupling system (not shown), comprising for example a servomotor controller, will command an actuating means (not shown), comprising for example a servomotor, to gradually decouple the stator from the rotor, according to the actual speed of the rotating disc (not shown).

In FIG. 10C and FIG. 10F, the conservative mode of operation of a permanent magnet motor-generator using a decoupling system is shown. This conservative mode occurs when no power is needed from the rotating disc and when no power is available from the power supply upwards the stator assemblies. In others words, in this mode, there is no power exchange. In this mode, the servomotor controller will totally decouple the stator from the rotor, as it will be detailed hereinafter.

FIG. 10G, as previously mentioned, is a graph illustrating the relationship between power, torque and speed of a permanent magnet motor using a decoupling system while FIG. 10I is a graph illustrating the relationship between the voltage across one of the phase of a permanent magnet motor and the speed of the permanent magnet motor for different values of the magnetic flux.

As previously mentioned, a relative displacement of the stator away from the rotor enables a rotational speed of the permanent magnet motor greater than a base speed thereof.

Indeed, as known to the skilled addressee. The electromotive force seen by a coil having n turns is:

$${e}^{′} = - n \frac{d ϕ}{d t} or {e}^{′} = - \frac{d Φ}{d t}$$

Where Φ is the total magnetic flux seen by the n turns of the coil and E′ is the electromotive force seen by the coil of a phase of the permanent magnet motor.

In a permanent magnet motor having a rotor and a stator, the back-electromotive force E is:

E=pΩΦ_{V}

Where p is the number of pairs of poles for each phase of the motor, Φ_{V} is the magnetic flux at no load for each phase and Ω is the rotational speed of the rotor of the motor.

As it can be seen, the back-electromotive force E increases with an increase of the rotational speed of the motor until E reaches the supply voltage of the motor. In order to prevent saturation of the supply voltage source supplying the motor-generator, one may reduce the magnetic flux Φ_{V} seen by the coils.

FIG. 8B shows the relationship between the voltage and the speed of a permanent magnet motor for a nominal value of the magnetic flux of 0.6 Wb, as well as for reduced values of the magnetic flux, i.e. a flux of 0.4 Wb and a flux of 0.2 Wb. As it should be apparent to the skilled addressee, these reduced values of the magnetic flux have been obtained in performing a relative displacement of the rotor with respect to the stator with a decoupling system.

As shown, it may be advantageous to reduce the magnetic flux seen by the motor once the base speed Ωb (2600 rpm in the illustrated case) of the machine has been reached and until reaching the maximal allowed speed of the motor. As previously mentioned, a faster speed than the base speed of the motor may be advantageous when the system is used with an energy storage flywheel allowing a rotational speed greater than the base speed of the motor.

As known to the skilled addressee, the losses at no load in the permanent magnet machine mainly comprise magnetic losses. The magnetic losses comprise the hysteresis losses and the losses induced by eddy currents. These two types of losses are directly dependant of the magnetic induction induced in the motor.

When the stator and the rotor of the motor are decoupled from each other, there is no magnetic interaction between the rotor and the stator and the magnetic induction is then negligible or even nil. Therefore, each of the hysteresis losses and the losses induced by eddy currents are also negligible or even nil.

The skilled addressee will appreciate that the decoupling system may be of great advantage when used with a flywheel energy storage system.

Indeed, for a given motor-generator designed for a power of 200 kW at a rotational base speed of 1500 rpm, calculation have shown that the magnetic losses are approximately 553 W. In other words, in the case the motor-generator is used with a 25 kWh flywheel, the flywheel should theoretically lost about 53% of its charge after a period of 24 hours due to the magnetic losses, which is not acceptable for a long term storage application.

The skilled addressee will therefore appreciate that the decoupling system is of great advantage in the case it is used in combination with a flywheel energy storage system for long term storage applications.

Referring again to FIG. 10I, the increasing of the operating rotational speed range is shown. The skilled addressee will appreciate that constant power may be extract or stock on the whole range of speed, which is of great advantage. In the illustrated embodiment, the operating rotational speed range is comprised between 2600 rpm, i.e. the base speed, and 8000 rpm, i.e. the maximal rotational speed allowed by the motor-generator or the maximal rotational speed allowed by the mechanical characteristics of the rotating flywheel, although other arrangements may be considered. As previously mentioned, this is particularly advantageous when using a flywheel having a high rotational speed much greater than the base speed of the motor-generator.

Referring now to FIG. 10H which schematically shows an embodiment of an energy storage system using a flywheel, the general principle of a system for decoupling a rotor from a stator of a permanent magnet motor will be described.

The illustrated flywheel energy storage system 1000 comprises a system 1050 for decoupling a rotor 1060 from a stator 1070 of a permanent magnet motor 1020. The system 1050 for decoupling a rotor 1060 from a stator 1070 of a permanent magnet motor 1020 comprises a displacement mechanism 1040 operatively connected to a selected one of the stator 1070 and the rotor 1060, the stator 1070 in the illustrated case, for displacing the selected one of the stator 1070 and the rotor 1060 between a first normal position wherein the stator 1070 extends around the rotor 1060 and a second position wherein the stator 1070 extends away from the rotor 1060 and is decoupled from the rotor 1060.

The system 1050 for decoupling a rotor 1060 from a stator 1070 of a permanent magnet motor 1020 also comprises actuating means 1080 operatively coupled to the displacement mechanism 1040 for actuating the displacement mechanism 1040. The system 1050 for decoupling a rotor 1060 from a stator 1070 of a permanent magnet motor 1020 also comprises a control unit (not shown) for controlling the actuating means 1080.

As illustrated and as further detailed thereinafter, in one embodiment, the flywheel energy storage system 1000 comprises a shaft 1030 operatively coupled to the system 1050 for driving a rotating flywheel 1090. In one embodiment, the flywheel energy storage system 1000 is mounted inside a containment vessel 1010.

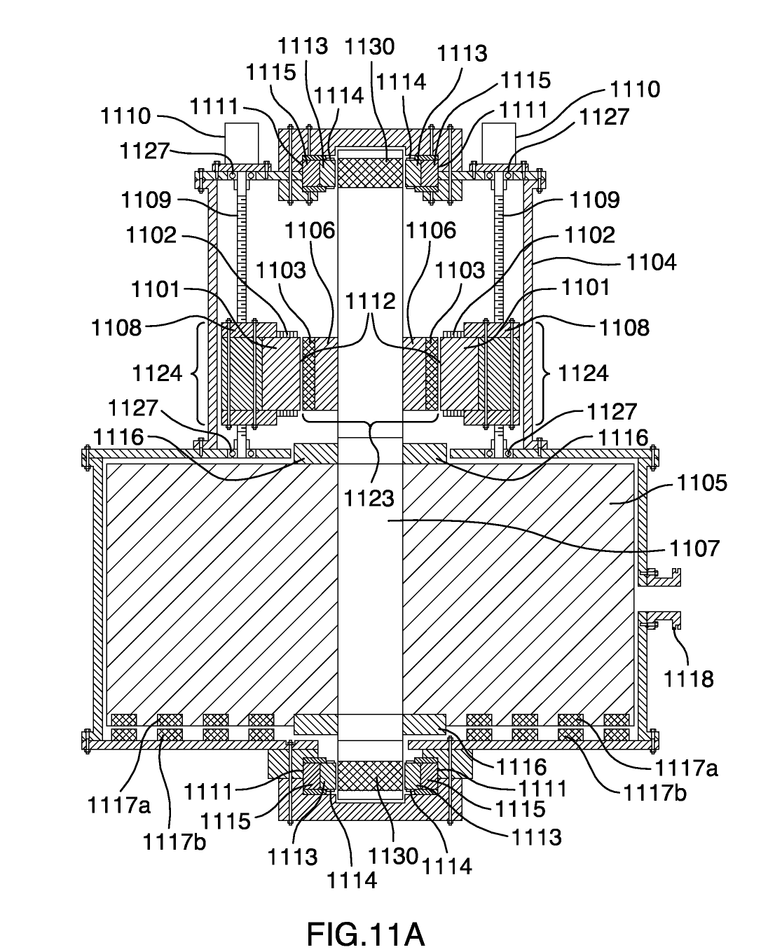

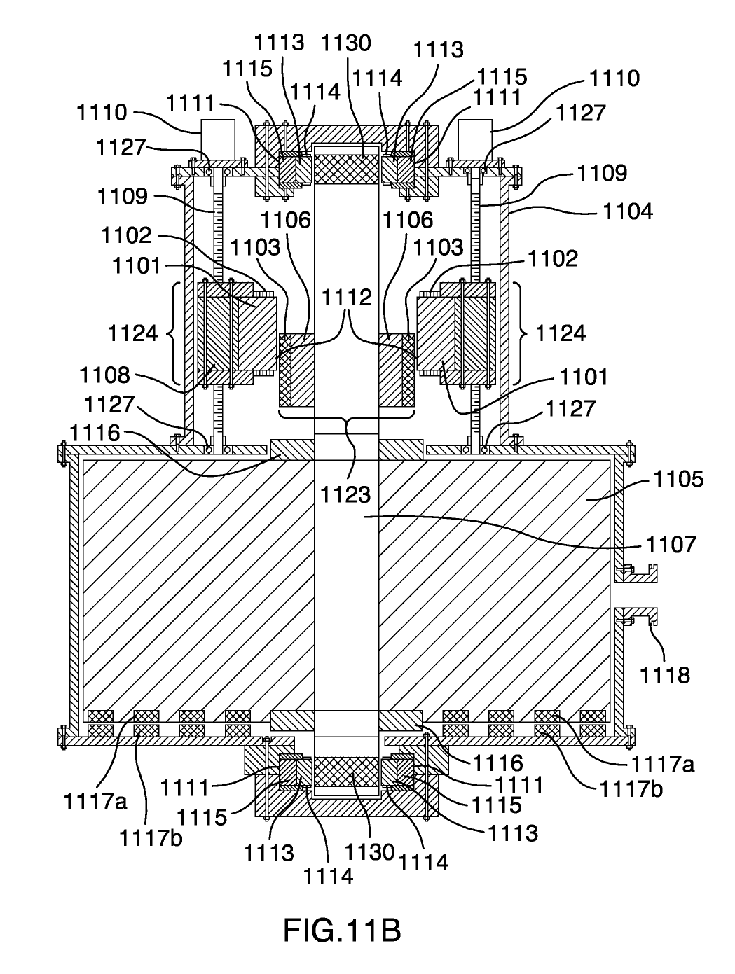

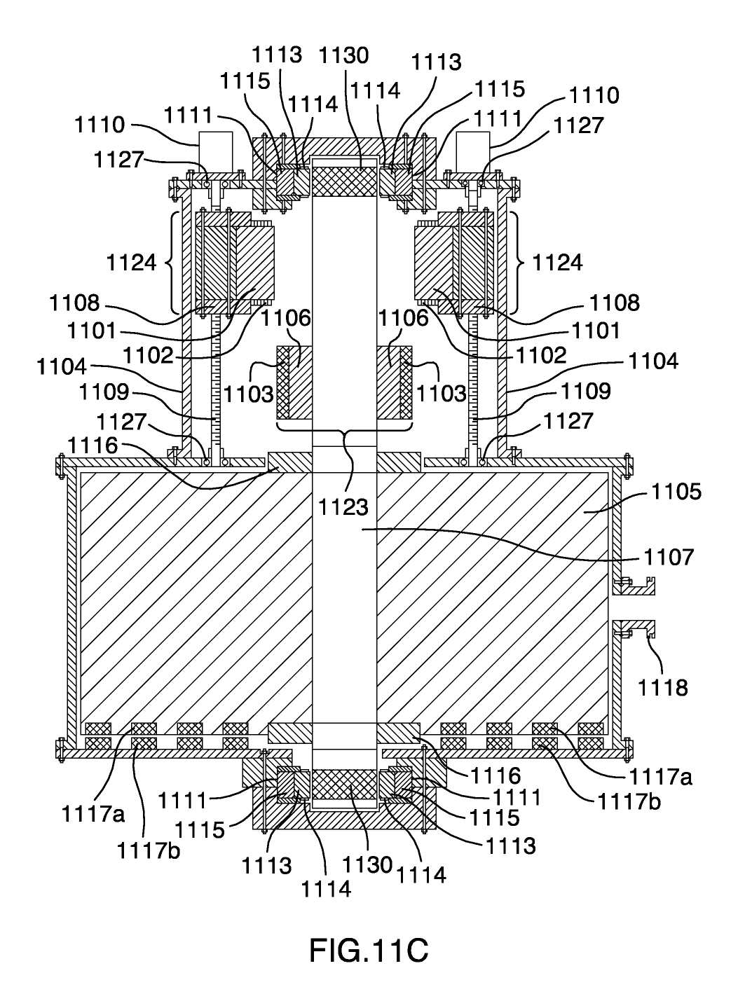

FIG. 11A shows an embodiment of a system for decoupling a rotor 1123 from a stator 1124 of a permanent magnet motor in the first normal position wherein the stator 1124 extends around the rotor 1123 and is coupled thereto, FIG. 11C shows the same system for decoupling a rotor from a stator of a permanent magnet motor in the second position wherein the stator 1124 extends away from the rotor 1123 and is decoupled from the rotor 1123. In other words, there is no magnetic interaction between the rotor 1123 and the stator 1124. FIG. 11B shows the system in an intermediate position wherein the stator 1124 is partially decoupled from the rotor 1123. This intermediate position enables the field weakening mode of operation described above with reference to FIG. 10E.

As illustrated in FIG. 11A, the permanent magnet motor is in the normal position where the rotor 1123 is aligned with the stator 1124 for enabling a maximum magnetic coupling. In one embodiment, the rotor 1123 is made of an iron element 1106 and rotates at the same speed than the electric frequency. Magnets 1103 are attached, with glue for example, on the iron element 1106 of the rotor 1123 and the rotor 1123 is fixedly mounted to the rotating shaft 1107. In the illustrated embodiment, the rotor 1123 is maintained as it rotates in the stator 1124 and the stator 1124 is deplaceable for enabling the field weakening operation mode and the conservative operation mode. The stator 1124, which comprises laminations 1101 and coils 1102 in the illustrated case, is supported by an aluminum casing 1108 to avoid magnetic interactions with the casing but any other suitable material preventing magnetic interaction may be used.

In the illustrated embodiment, the stator aluminum casing 1108 has a first and a second threaded holes for mounting with a first and a second screw 1109 to support the stator 1124. The first and second screws 1109 are driven by a first servomotor and a second servomotor 1110 controlled by a servomotor controller (not shown) for precise displacement of the stator 1124 according to the suitable speed that the system requires.

In one embodiment, the rotation of the screws 1109 driven by the servomotors 1110 is assured by mechanical bearings 1127 but the skilled addressee will appreciate that other types of bearings may be used, such for, as a non-limitative example, magnetic bearings. In the normal position of the stator 1124, the screws 1109 maintain the stator 1124 in a way that the air gap 1112 between the stator 1124 and the rotor 1123 is constant.

In the illustrated embodiment, the rotor 1123 of the permanent magnet motor and the rotating disc 1105 are coupled together and to a rotating shaft 1107. They are axially maintained by an upper and a lower magnetic bearings 1111 to minimize the friction losses that may be caused by mechanical bearings. In one embodiment, the rotating part 1130 of the magnetic bearings 1111 is made of ferromagnetic material to minimize the magnetic losses in the magnetic bearings 1111.

In one embodiment, the rotating disc 1105 is maintained on the rotating shaft 1107 by two couplings 1116. Moreover, the rotating disc 1105 lies on a set of opposite magnets 1117a, 1117b. In this way, the rotating disc 1105 levitates above the set of bearings 1117b and the friction losses are minimized.

In the embodiment illustrated in FIG. 11B, the stator 1124 is 50% decoupled from the rotor 1123. Therefore, there is less magnetic interaction between the rotor 1123 and the stator 1124, as previously explained. In the embodiment illustrated in FIG. 11C, the stator 1124 is totally decoupled from the rotor 1123. Therefore, there is no magnetic interaction between the rotor 1123 and the stator 1124.

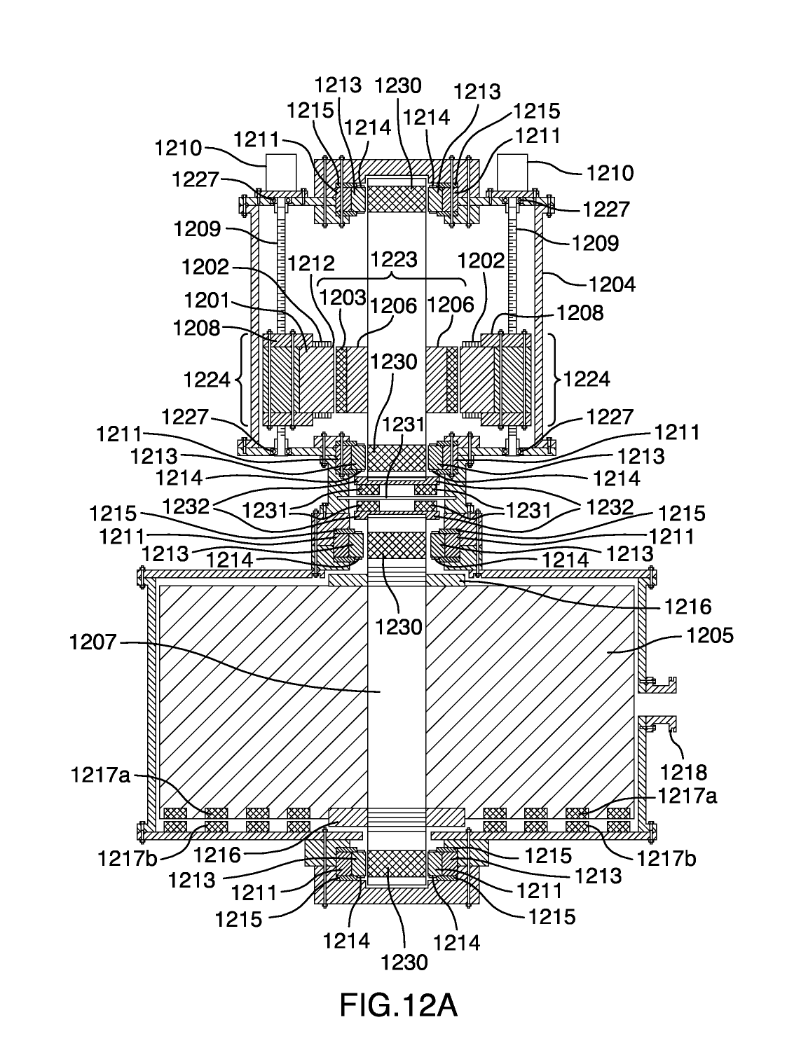

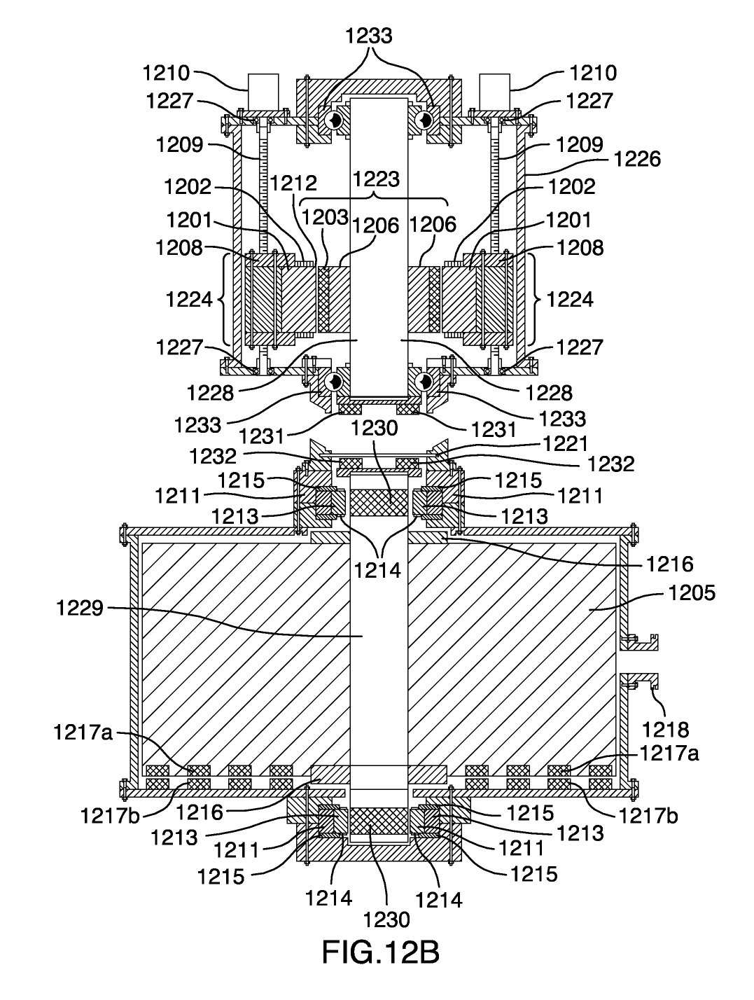

Referring now to FIG. 12A and FIG. 12B, another embodiment of a flywheel energy storage system using a permanent magnet motor as a magnetic active coupler is partially shown. In the illustrated embodiment, the rotating disc 1205 is mounted in a hermetic containment vessel 1219 (shown in FIG. 12B) which is isolated from the magnetic active coupler, i.e. the permanent magnet motor, through a magnetic clutch and a non-magnetic element 1221.

This embodiment provides an isolation of the rotating disc 1205 from the magnetic active coupler by a non magnetic element 1221 to enable minimizing the volume of air that should be vacuumed to minimize the aerodynamics losses.

The permanent magnet motor comprising the rotor 1223 and the stator 1224 is mounted in its own containment vessel 1226 (shown in FIG. 12B) while the rotating disc 1205 is mounted in its own containment vessel 1219.

In the illustrated embodiment, the rotor 1223 of the permanent magnet motor rotates with the rotating shaft 1228 (shown in FIG. 12B) while the rotating disc 1205 rotates with the rotating shaft 1229 (shown in FIG. 12B). The rotating shaft 1229 is axially maintained with two magnetic bearings 1211 in order to minimize the friction losses caused by mechanical bearings. The shaft 1228 of the motor-generator is linked to the shaft 1229 of the rotating disc 1205 through a magnetic clutch 1220. The magnetic clutch 1220 enables a torque transfer between both shafts 1228, 1229 without any mechanical contact. In the illustrated embodiment, the magnetic clutch 1220 comprises two sets of magnets 1231 lying on an iron disc 1232 that assure the torque transfer.

As best shown in FIG. 12B, the magnetic active coupler may be pulled apart from the isolated rotating disc 1205. To this effect, the flywheel energy storage system comprises mechanical bearings 1233 (shown in FIG. 12B) on the shaft 1228 of the permanent magnet motor. In this way, the magnetic active coupler may be pulled apart from the rotating disc containment vessel 1219 when it is in the conservative mode to thereby cancel the friction losses caused by the rotating parts on the side of the permanent magnet motor containment vessel 1226. The mechanical bearings 1233 may comprise oil film bearings, but the skilled addressee will appreciate that any other types of bearings may be used.

The motor-generator containment vessel 1226 may be pulled apart from the rotating disc containment vessel 1219 by a suitable mechanism (not shown), which may be a mechanical mechanism, a robotic mechanism, a pneumatic mechanism or any convenient means adapted to achieve the required displacement.

Referring now to FIG. 13, the flywheel energy storage system described above may be adapted to be coupled to a plurality of independent rotating discs 1305, three in the illustrated case. In this case, a mechanism (not shown) is provided for displacing either the containment vessel 1326 either the containment vessels 1319 so that kinetic energy may be stored and retrieve from any of the discs 1305.

This embodiment may be particularly useful in the case a stand-alone energy source is used since one of the rotating discs 1305 may be used to store energy therein while another disc 1305 may be used concurrently to provide a portion of the stored energy.

In one embodiment, the actuating means may be selected from a group consisting of a servomotor, a pneumatic actuator and an hydraulic actuator. In a further embodiment, a plurality of actuators or cylinders may be used. The skilled addressee will appreciate that various other actuating means as well as various other control units may be considered.

The skilled addressee will also appreciate that the relative displacement of the rotor with respect to the stator may be implemented such that the displacement may be a continuous motion. Alternatively, the motion may be implemented using incremental discrete displacements.

In one embodiment, the actual speed may be measured with an optical sensor but the skilled addressee will appreciate that various other arrangements may be alternatively considered.

Moreover, in a further embodiment, a position sensor for sensing a relative position of the stator with respect to the rotor may be used. In still a further embodiment, a feedback loop may be implemented for a given application.

The skilled addressee will appreciate that an energy storage system according to the present invention and using a system for decoupling a rotor from a stator of a permanent magnet motor may enable to provide a more efficient storage, particularly for medium and long term energy storage applications.

The skilled addressee will also appreciate that an energy storage system as described above and embedding the high power density flywheel, the system for decoupling a rotor from a stator of a permanent magnet motor and a convenient number of dual switching frequency hybrid power converter may provide an even more efficient energy storage, particularly for medium and long term energy storage applications.

The skilled addressee will appreciate, upon reading of the present description, that the energy storage system may enable an energy conservation of 95% over a 24 hour period when no energy is extracted from the energy storage system. Moreover, the energy storage system may also enable a round trip efficiency, i.e. the transfer efficiency from the electrical grid to the storage system and from the storage system to the electrical grid again, of more than 85%.

Indeed, a theoretical simulation has been performed for estimating the efficiency. Losses in the semi-conductors, losses induced by the required filtering, magnetics losses as well as aerodynamic losses and mechanical losses have been estimated for a preferred one embodiment and conduct to a theoretical energy conservation of 95% with a round trip efficiency above 85%.

As previously mentioned, the skilled addressee will appreciate that such an energy storage system may be particularly useful in charging infrastructure for electric vehicles or plug-in hybrid electric vehicles at a constant rate, which is of great advantage.

Moreover, the energy storage system may also be of particular interest in applications where a great quantity of energy is requested over a brief period of time, such as the ultra fast charging of electrical vehicles in few minutes. Indeed, the energy storage system may provide the requested quantity of energy over a brief period of time without unbalancing the electrical distribution network.

The skilled addressee will appreciate that the energy storage system may also be useful to stabilize fluctuations of an electrical network, to support the electric grid for load leveling, peak shaving, voltage and frequency regulation, renewable energy integration and for other applications where constant or variable power is necessary.

The skilled addressee will also appreciate that the energy storage system may be used to provide energy storing units distributed over the whole electrical distribution network. Indeed, the energy storage system may be installed in any area, including urban areas wherein it may be desirable to maintain an energy storing capacity.

The skilled addressee will also appreciate that the energy storage system may also be useful to provide a reliable UPS (Uninterruptible Power Supply). Indeed, contrary to the batteries based UPS, a UPS storing energy in a flywheel may be more reliable and have a long service life, which is of great advantage.

It should also be mentioned that an energy storing system using a flywheel as a reservoir of energy may be less expensive to maintain over a long term period. Indeed, while batteries based systems must be periodically checked since the batteries typically have to be replaced every two to four years at least, the flywheel may store and retrieve energy over 20 years, without any need to replace the flywheel. Thus, although the energy storage system may be more expensive to implement, it may be less expensive over the time since the maintenance costs are greatly reduced.

The skilled addressee will also appreciate that such an energy storage system may be of particular interest for implementing a method for storing energy and restoring such energy upon request. Indeed, as mentioned above, the system may be used to store available energy during the off-hours peak periods and to restitute the stored energy during the peak periods. With this method, the overall energy production may be more efficiently used, which is of great advantage. Moreover, the method may also help reducing the number of power plants that may be needed just to respond to the peak periods, which is also of great advantage.

In some countries, the pricing of energy may be variable according to the period of the day. In this case, the system may help in implementing a method for doing business in which the energy is stored during the off-hours peak periods wherein the energy is less expensive and in which the stored energy is restituted during the peak periods wherein the energy is more expensive.

In one embodiment, the communication system 218 (shown in FIG. 2 to FIG. 5) may be used to implement such a method for doing business. In another embodiment, the communication system 218 may be used to control the operation of the energy storage system in real-time according to the instantaneous power available on the distribution network and the power demand. The communication system 218 may be adapted for sending data to the control unit 210 through control signals in a wired configuration or in a wireless configuration, according to a specific application.

According to another aspect, there is also provided a method of doing business in using the energy storage system as previously defined, the method comprising storing electric energy during off-hours peak consumption periods; and restituting the stored energy during peak consumption periods.

In one embodiment, the using is done by a third party.

According to another aspect, there is also provided a method of doing business in using the energy storage system as previously defined, the method comprising providing by a provider an energy storage system as previously defined to a third party; operating the energy storage system wherein the operating is done by a third party for a fee; and reconveying by the third party a portion of the fee to the provider.

The skilled addressee will also appreciate that, contrary to other systems such as compressed air energy storage systems, the totality of the energy stored in the flywheel may be restituted, which is of great advantage.

Although the above description relates to specific preferred embodiments as presently contemplated by the inventors, it will be understood that the invention in its broad aspect includes mechanical and functional equivalents of the elements described herein.

1-67. (canceled)

68. An energy storage system operatively connectable to at least one of an electrical energy source and an electrical distribution network for storing electrical energy thereof over at least a medium term duration, said energy storage system comprising:
a motor assembly operatively connectable to at least one of the electrical energy source and the electrical distribution network for providing kinetic energy;
a flywheel device operatively connectable to the motor assembly for storing at least one part of said kinetic energy;
a generator assembly operatively connectable to the flywheel device for receiving at least one portion of said part of said kinetic energy and generating regenerated electrical energy in response thereto; and
a control unit for controlling operation of the energy storage system, said control unit enabling an energy storage operating mode wherein said motor assembly is connected to said flywheel device and at least one of the electrical energy source and the electrical distribution network for storing said part of said kinetic energy into the flywheel device, and an energy supply operating mode wherein said generator assembly is operatively connected to said flywheel device and at least one of the electrical distribution network and an electrical appliance for providing at least one portion of said regenerated electrical energy thereto.

69. The energy storage system according to claim 68, further comprising a permanent magnet motor-generator, said permanent magnet motor-generator comprising the motor assembly and the generator assembly.

70. The energy storage system according to claim 68, further comprising a bidirectional electronic power converter operatively associated with the motor assembly and the generator assembly, said converter being adapted for converting the regenerated electrical energy into converted electrical energy enabling a corresponding electrical power exchange between the generator assembly and at least one of the electrical distribution network and the electrical appliance.

71. The energy storage system according to claim 68, wherein the energy storage system is operatively connected to the electrical energy source, said electrical energy source comprising at least one stand-alone renewable electrical energy source, said generator assembly being operatively connected to the electrical appliance, thereby providing a stand-alone configuration of the energy storage system.

72. The energy storage system according to claim 68, wherein the flywheel device comprises a high energy density flywheel having a central rotating axle for storing kinetic energy, said high energy density flywheel comprising:
a first member to be operatively mounted around the central rotating axle, said first member comprising a first material having a given high mass density enabling a given high kinetic energy storage capacity; and
a second member operatively attached to the first member, said second member surrounding an outside portion of said first member subject to radial forces generated by a rotation of said flywheel, said second member comprising a second material having a given high yield strength enabling a given high maximum rotational speed;
wherein the second member enables an operation of the high energy density flywheel at a given high flywheel rotational speed, to thereby provide the flywheel with a given high kinetic energy storage capacity.

73. The energy storage system according to claim 72, wherein the high energy density flywheel is adapted to be mountable on a rotating shaft operatively connectable to each of the motor assembly and the generator assembly.

74. The energy storage system according to claim 72, wherein the high energy density flywheel further comprises a magnetic coupling element mounted on an inner side thereof and adapted for interacting with an associated magnetic driving element mountable proximate the central rotating axle.

75. The energy storage system according to claim 72, wherein the second member of the high energy density flywheel wholly encloses the first member.

76. The energy storage system according to claim 72, wherein the first member of the high energy density flywheel has a toroidal shape.

77. The energy storage system according to claim 76, wherein the second member of the high energy density flywheel has an empty toroidal shape wholly enclosing the first member.

78. The energy storage system according to claim 77, wherein the second member of the high energy density flywheel comprises at least three covers, each being wound on the first member.

79. The energy storage system according to claim 78, wherein each of the three covers is wound on the first member of the high energy density flywheel according to a respective principal direction thereof.

80. The energy storage system according to claim 79, wherein a first one of the three covers is axially wound on the first member, a second one of the three covers is circumferentially wound on the first member and a third one of the three covers is wound at 45 degrees with respect to the first one of the three covers.

81. The energy storage system according to claim 69, further comprising at least one dual switching frequency hybrid power converter adapted to be operatively connected between the permanent magnet motor-generator and at least one of the electrical distribution network and the electrical appliance for voltage conversion, said dual switching frequency hybrid power converter comprising:
a first leg electrically connected to the permanent magnet motor-generator, said first leg comprising a high side switch and a low side switch serially connected, the high side switch comprising a selected one of a first switching element having low conduction losses and a second switching element having low commutation losses and the low side switch comprising the remaining of a first switching element having low conduction losses and a second switching element having low commutation losses, said first leg further comprising an anti-parallel diode operatively connected in a parallel relationship with the first switching element; and
a second leg electrically connected to the permanent magnet motor-generator in a parallel relationship with the first leg, said second leg comprising a high side switch and a low side switch serially connected, the high side switch comprising a selected one of a first switching element having low conduction losses and a second switching element having low commutation losses corresponding to the one selected for the high side switch of the first leg and the low side switch comprising the remaining of a first switching element having low conduction losses and a second switching element having low commutation losses, said second leg further comprising an anti-parallel diode operatively connected in a parallel relationship with the first switching element;
wherein each of the first switching elements is operated at a low fundamental frequency and each of the second switching elements is operated at a high frequency greater than the low fundamental frequency for enabling a bidirectional voltage conversion between the first element and the second element.

82. The energy storage system according to claim 81, wherein each of said first switching elements comprises at least one IGBT.

83. The energy storage system according to claim 81, wherein each of said first switching elements is selected from a group consisting of a thyristor, a GTO, an IGCT and a MCT.

84. The energy storage system according to claim 81, wherein each of said first switching elements comprises a plurality of switching devices connected in parallel and each of said second switching elements comprises a plurality of switching devices connected in parallel.

85. The energy storage system according to claim 81, wherein each of said first leg and second leg comprises an additional anti-parallel diode operatively connected in a parallel relationship with the corresponding second switching element.

86. The energy storage system according to claim 81, wherein the dual switching frequency hybrid power converter further comprises a third leg electrically connected to the permanent magnet motor-generator in a parallel relationship with the first leg and the second leg, said third leg comprising a high side switch and a low side switch serially connected, the high side switch comprising a selected one of a first switching element having low conduction losses and a second switching element having low commutation losses corresponding to the one selected for the high side switch of the first leg and the low side switch comprising the remaining of a first switching element having low conduction losses and a second switching element having low commutation losses, said third leg further comprising an anti-parallel diode operatively connected in a parallel relationship with the first switching element, thereby enabling a three phase voltage conversion.

87. The energy storage system according to claim 69, further comprising a system for decoupling a rotor from a stator of the permanent magnet motor generator comprising:
a displacement mechanism operatively connected to a selected one of the stator and the rotor for displacing the selected one of the stator and the rotor between a first position wherein the stator extends around the rotor and a second position wherein the stator extends away from the rotor and is decoupled from the rotor;
actuating means operatively coupled to the displacement mechanism for actuating said displacement mechanism; and
a decoupling control unit for controlling the actuating means;
wherein a relative displacement of the stator away from the rotor enables a rotational speed of the permanent magnet motor generator greater than a base speed thereof.
